(19) United States
(12) Patent Application Publication
(10) Pub. No.: US 2013/0163707 A1
(43) Pub. Date: Jun. 27, 2013

(54) Method for Producing Isotopes, in particular Method for Producing Radioisotopes by Means of Gamma-Beam Irradiation

(71) Applicants: Ludwig-Maximilians-Universitat Munchen, Munchen (DE); Institut Max von Laue - Paul Langevin, Grenoble Cedex (FR)

(72) Inventors: Dietrich Habs, Schriesheim (DE); Ulli Köster, Grenoble Cedex 9 (FR)

(73) Assignees: Institut Max von Laue - Paul Langevin, Grenoble Cedex (FR); Ludwig-Maximilians-Universitat Munchen, Munchen (DE)

(21) Appl. No.: 13/770,102

(22) Filed: Feb. 19, 2013

Related U.S. Application Data
(63) Continuation of application No. PCT/EP2011/004194, filed on Aug. 19, 2011.

(30) Foreign Application Priority Data
Aug. 5, 2010 (EP) 10186576.4
Aug. 20, 2010 (EP) 10008708.9

(51) Int. Cl. G21G 1/12

(52) U.S. Cl. CPC G21G 1/12
USPC 376/157

(57) ABSTRACT

A method is described for producing a radionuclide product B. A target is provided which includes an amount of a nuclide A. A gamma (γ) beam from Compton back-scattering of laser light from an electron beam irradiates the target and thereby transmutes at least a portion of the amount of the nuclide A into the product B. Providing the target includes selecting a nuclide A which is transmutable into product B by a gamma (γ) induced nuclear reaction.

This application is a continuation of Patent Cooperation Treaty Patent Application PCT/EP2011/004194, filed Aug. 19, 2011, which in turn claims priority from European Patent Application 10 008 708.9, filed Aug. 20, 2010, and from European Patent Application 10 186 576.4, filed Oct. 5, 2010; all of which are incorporated herein by reference.

### FIELD OF THE INVENTION

The invention relates to a method for producing isotopes, in particular to a method for producing radioisotopes by means of gamma (γ) beam irradiation.

### BACKGROUND OF THE INVENTION

Radioisotopes are often produced by means of (n, γ) reactions in nuclear reactors or by charged particle (mainly p, d, α) induced reactions where the charged particle beam is usually provided by a cyclotron. In principle also photonuclear reactions, such as e.g. (γ, n) reactions, could be used. However, the activities or specific activities achieved by previously employed photonuclear reactions using Bremsstrahlung are usually too low for many applications, and in particular medical applications. Photonuclear reactions using Bremsstrahlung are discussed, e.g., by O.D. Maslov et. al. in “Preparation of ²²⁵Ac by ²²⁶Ra(γ,n) Photonuclear Reaction on an Electron Accelerator, MT-25 Microtron”, Radiochemistry 48, 195 (2006). The achieved activities of 550 Bq/(μA*11) are too low for a large scale supply for, e.g. medical applications.

Using Bremsstrahlung, the achievable activity of the produced radionuclide is often limited as the energy spectrum of the generated photons is very broad. In particular, for Bremsstrahlung beams, there is a strong rise of the gamma (γ) spectrum at low energies. In addition, commonly used target materials may have larger absorption cross sections at lower energies. Consequently, in addition to the desired nuclear reaction a plethora of further unwanted reactions can be induced. These unwanted reactions may result in the production of unwanted isotopes and elements which may contaminate the produced material. As a further consequence the target is heated up excessively, resulting in a practical limit for the usable beam intensities. Consequently, the specific activities which are achieved by Bremsstrahlung are usually very limited.

Alternatively, radioactive isotopes for medical purposes are often produced by neutron capture in nuclear reactors. During neutron capture (n, γ) reactions, a stable isotope is transmuted into a radioactive isotope of the same element. The production of radioactive isotopes by means of neutron capture in nuclear reactors is generally less subject to thermal limitations, but unfortunately suffers from several other limitations. First, producing radioactive isotopes by neutron capture is generally limited to radioisotopes that have a stable and sufficiently abundant (A−1) target isotope. Moreover, the specific activities that can be achieved are limited by the cross section for the (n, γ) reaction and the available neutron flux.

Charged particle induced reactions allow producing products with relatively high specific activity (after chemical separation from the target). World-wide more than 600 compact cyclotrons exist that provide charged particle beams with 10 to 20 MeV energy which are suitable for the production of PET tracers. They provide regularly short-lived PET isotopes such as ¹⁸F (with a half-life T_{1/2} of 110 min), ¹¹C (T_{1/2}=20 min), ¹³N (T_{1/2}=10 min) and ¹⁵O (T_{1/2}=2 min) that can be employed for molecular imaging applications. However, large scale production of therapy isotopes would require very large accelerators. Eventually the producible activities will be limited by the high energy deposition of the charged particle beam in the production target and the difficulty to dissipate this beam power.

It is thus desirable to provide a method for efficiently producing radioactive isotopes with high specific activity. Moreover, it is desirable to produce the desired isotope with high purity. In addition, it is preferred to provide such a method that can be applied to produce the desired isotopes at an industrial scale at low cost.

### SUMMARY OF THE INVENTION

The present invention solves this problem by providing a method for producing a radionuclide product according to claim 1 and by providing an apparatus according to claim 13.

In a first aspect of the invention, the problem is solved by providing a method for producing a radionuclide product B comprising the steps of providing a target comprising an amount of a nuclide A, and providing a gamma (γ) beam. The method further comprises irradiating the target by the gamma beam, thereby transmuting at least a portion of the amount of the nuclide A into the product B. Providing the target comprises selecting a nuclide A, such that A is transmutable into product B by a γ induced nuclear reaction. Moreover, providing the gamma beam comprises providing a gamma beam by Compton back-scattering of laser light from an electron beam.

This method is especially useful for the production of radioisotopes for medical purposes, in particular for therapy and diagnosis. The produced radionuclides are useful for treatment and diagnosis for, both, humans and animals.

Providing a gamma beam by means of Compton back-scattering of an intense laser beam from an intense relativistic electron beam results in a high-intensity gamma beam. Moreover, the resulting gamma beam has a low bandwidth and a small opening angle, corresponding to a small beam spot. High γ energies can be achieved by using relativistic electron beams of sufficient energy. Further, this method can be carried out with a facility that can be compactly built.

The advantageous properties of Compton back-scattered gamma beams result in a high specific activity of the produced material which can moreover be generated in a rather short irradiation time. In particular, the high intensity, low bandwidth and small opening angle of the gamma beams lead to a high activity being reached in short time. The reduced irradiation time leads to a higher throughput when using the proposed method.

One other advantage of the gamma beam facility is the new and rather unique access to radioisotopes or isomers with high specific activity that can complement and extend the choice of radioisotopes for nuclear medicine applications.

In a preferred embodiment, selecting a nuclide A comprises selecting a nuclide A which is transmutable into product B by a (γ, xn+yp+zy′) reaction with x+y+z≧1, in particular, by a (γ, γ′) reaction, a (γ, n) reaction, a (γ, p) reaction, or a (γ, 2n) reaction.

The latter conversion reactions are preferred, as only one or two additional particles are generated. As these particles may lead to undesired further nuclear reactions, giving rise to unwanted reaction products and impurities, limiting their number is advantageous.

In a preferred embodiment, providing the gamma beam comprises providing the gamma beam with an adjustable photon energy. The method then further comprises the step of adjusting the photon energy in accordance with the product B and the selected nuclide A.

Using Compton back-scattering of laser light from an electron beam for providing the gamma beam, the photon energy can e.g. be adjusted by adjusting the energy of the electron beam. This can be accomplished by using an electron accelerator and by adjusting the acceleration parameters of the electron beam. Other important parameters of the accelerator are the current and the repetition rate. Alternatively or additionally, the energy of the laser pulses can also be adjusted. In this way, the gamma beam energy can be tuned to increase the reaction rate for the desired transmutation of nuclide A into product B, leading to a higher specific activity.

In a preferred embodiment, providing the gamma beam comprises providing the electron beam by a LINAC, preferentially an energy recovery linac (ERL) or a warm linac, or a laser-driven electron beam. These electron beam sources are advantageous over a synchrotron, which would be the typical choice, as the circulating electron beam of a synchrotron would be perturbed by the Compton-backscattering process, thus allowing only a production of lower γ flux. In particular, also the transversal emittance and the energy spread of the electron beam are usually much worse as compared to a linac. Consequently, the resulting γ beam would have a much larger band width. While this appears to be acceptable for non-resonant reactions, it does not seem acceptable for resonant reactions for which a high spectral flux density is required. Generally, special measures are needed to significantly improve the electron beam quality of a synchrotron. Nevertheless, it is believed that a synchrotron could also be used in the framework of the present invention.

Using the energy recovery linac to generate a gamma beam is described in detail by R. Hajima, N. Nakamura, S. Sakanaka and Y. Kobayashi in KEK Report 2007-7, JAEA-Research 2008-032, February 2008.

The energy-recovery linac (ERL) is a new class of linear accelerator which produces an electron beam of small emittance and high-average current as described e.g. by R. Hajima in “Current status and future perspectives of energy-recovery linacs”, in Proc. 2009 Particle Accelerator Conference (2009). In an energy-recovery linac, an electron beam is accelerated by a superconducting radio-frequency (rf) linac, and after use the beam is decelerated in the same linac. Thus the electron energy is converted back into rf energy and recycled to accelerate succeeding electrons. This process is referred to as “energy recovery”. The energy-recovery allows to accelerate an electron beam of high-average current with rf generators of smaller power. Moreover, the ERL is free from degradation of electron beam emittance caused by multiple recirculations of electrons, because an electron bunch in the ERL goes to a beam dump after deceleration and a fresh electron bunch is accelerated every turn. The beam emittance of an ERL can be improved by adopting a small-emittance injector such as a photocathode electron gun. The generation of an electron beam with high-average current and small emittance favourably distinguishes the ERL from other type of accelerators.

In an ERL, the electron beam is provided in monochromatic electron bunches of high energy. As a result, high-energy, monochromatic gamma beams are provided. This leads to a high specific activity for the product B.

The use of warm linacs is described in detail by F. Albert et al., “Isotope specific detection of low-density materials with laser-based monoenergetic gamma-rays”, Optic Letters, 35, page 354, 2010. Here, expensive cooling facilities are omitted, leading to a cheaper way of realising the advantages of the present invention.

In alternative embodiments, the electron beam can be provided by a linear accelerator of different types, by a synchrotron or by laser-driven accelerators. The latter method is described in detail by D. Habs et al “Dense laser-driven electron sheets as relativistic mirrors for coherent production of brilliant X-ray and γ-ray beams”, Appl. Phys. B, 93, page 349, 2008. In particular, the electron beam can be provided as one or more electron bunches. While providing the electron beam by a synchrotron is possible, for reasons given above it is not preferred for the present invention.

In a preferred embodiment, the target comprises the nuclide A in enriched form or in natural abundance.

Providing the nuclide in enriched form leads to a higher achievable irradiation yield as a higher percentage of the target can be transmuted into the desired radionuclide B. If the nuclide is provided in natural abundance, less processing is needed to prepare the target, thus leading to reduced costs for the target.

In a preferred embodiment, the gamma beam has a flux density between 10¹⁰ and 10²¹ γ/(s cm²), in particular between 10¹¹ and 10²⁰ γ/(s cm²), and preferably between 10¹³ and 10¹⁹ γ/(s cm²). This flux density is to be understood to be present at the position of the target.

A high flux density results in a high reaction rate for the nuclear transmutation of nuclide A into product B. Choosing the flux density too high, however, can lead to an excessive heating of the target.

In a preferred embodiment, providing the gamma beam comprises providing the gamma beam with an opening angle of less than 10 mrad, in particular of less than 1 mrad, and preferably of less than 200 μrad.

The small opening angle leads to a better concentration of the gamma beams, such that a small target can be used. Moreover, this small opening angle allows “reusing” those γ rays passing a first target without interaction, such that multiple targets can be used which are put one behind the other.

In a preferred embodiment of the invention, the gamma beam is focussed by at least one refractive γ-lens. This way the flux density of the gamma beam may be further increased, which leads to an improved conversion or transmutation efficiency. This is of particular importance when targets containing nuclide A in enriched form are used. The costs of enriched targets are comparatively high, so that from an economical point of view the radionuclide B production is particularly attractive if the enriched nuclide A is transmuted with a high efficiency, which efficiency can be significantly increased by focussing the gamma beam with said refractive γ-lens.

Since the index of refraction for gamma photons is slightly smaller than unity, a focusing refractive γ-lens requires a concave shape. Unfortunately, the refraction of gamma rays in matter is very weak. This can be accounted for by stacking multiple single lenses, one behind the other. Herein, the number of stacked γ-lenses may be between 1 and 10,000, preferably between 10 and 10,000 and most preferably between 1,000 and 5,000.

In a preferred embodiment of the invention, the at least one refractive γ-lens is provided with a concave shape, wherein the concave shape has a radius of curvature between 1 mm and 1 μm, in particular between 500 μm and 1 μm, preferably between 250 μm and 1 μm, and most preferably between 50 μm and 1 μm.

Since the refraction of gamma rays in matter is very weak, a small radius of curvature of the concave shape is required to increase the refraction power of each single γ-lens.

In a preferred embodiment of the invention, the refractive γ-lens is provided with a parabolic shape.

In a preferred embodiment, providing the gamma beam comprises providing the gamma beam with an intensity of more than 10¹⁰ photons per second, in particular between 10¹¹ and 10²⁰ photons per second, preferably between 10¹¹ and 10¹⁷ photons per second, and most preferably between 10¹³ and 10¹⁶ photons per second.

The high gamma beam-intensity which can be achieved by Compton back-scattering leads to a reduced irradiation time. In particular, the number of target batches per a given time can be increased considerably by using a gamma beam of high intensity.

In a preferred embodiment, providing the gamma beam comprises providing the gamma beam with an energy bandwidth between 10⁻² and 10⁻¹², in particular between 10⁻² and 10⁻¹⁰, preferably between 10⁻³ and 10⁻⁸, more preferably between 10⁻³ and 10⁻⁷, and most preferably between 10⁻⁴ and 10⁻⁷.

By providing the gamma beam by Compton back-scattering, a very low energy bandwidth ΔE/E can be achieved. The bandwidth values given herein are to be understood as defined by full width half maximum (FWHM). A low energy bandwidth corresponds to highly monochromatic gamma beams. As a result of such highly monochromatic gamma beams, nuclear reactions can be induced very selectively. This results in a high cross-section for the desired nuclear reaction. Consequently, a high specific activity of the product can be achieved in a shorter time. Moreover, this leads to an additional strong reduction of the required target mass, which further reduces the target costs. Moreover, undesired nuclear processes inducible by gamma beams at other energies are suppressed due to the highly monochromatic gamma beams.

In addition due to the monochromatic beams radiation damage observed for wider γ spectra can be greatly reduced. This e.g. allows to first dope and then activate materials like organic or nanoscale materials that would not withstand a radiation in a nuclear reactor or a Bremsstrahlung gamma beam spectrum. Moreover, also less stringent requirements exist concerning chemical impurities of target materials. These reduced requirements are also a consequence of the use of monochromatic beams, avoiding activation of impurities. The existence of impurities in the material is thus less likely to generate unwanted products. Due to the higher purity of the produced isotopes, also the challenge to the chemical post-processing is reduced, if the isotope is applied for medical purposes.

In a preferred embodiment, providing the gamma beam comprises providing the gamma beam with a cross section between 1 μm² and 10 mm², in particular between 100 μm² and 1 mm², and preferably between 1000 μm² and 50000 μm² at the target location.

Providing gamma beams by Compton back-scattering leads to small beam spot sizes. This allows for irradiation of small target sizes with high intensities. Using small targets, reaction by-products like neutrons and protons will pass only a small length before leaving the target. This way, the probability for secondary reactions in the target induced by by-products is reduced.

In a preferred embodiment, providing the gamma beam comprises providing a gamma beam with a photon energy between 0.4 and 40 MeV, in particular between 0.5 and 30 MeV, and preferably between 0.5 and 10 MeV for (γ,γ′) reactions, between 5 and 20 MeV for (γ,n) reactions, between 9 and 30 MeV for (γ,p) reactions and between 12 and 30 MeV for (γ,2n) reactions.

As will be described in more detail below, many desired nuclear reactions for the production of isotopes, in particular for medical purposes, happen at high gamma beam energies. Applying high energy gamma beams to the nuclide A will thus lead to the production of the desired isotopes with high specific activity. The range of 0.5 to 10 MeV is especially preferred if nuclide A is transmutable into product B by a (γ,γ′) reaction, the range of 5 to 20 MeV is especially preferred for (γ,n) reactions, the range of 9 to 30 MeV is especially preferred for (γ,p) reactions, while the range of 12 to 30 MeV is especially preferred for (γ,2n) reactions.

Preferably, the method comprises selecting the nuclide A depending on the desired radionuclide product B from the following list of combinations of nuclide A, nuclear reaction, and radionuclide B:
¹⁹⁵Pt(γ,γ′)^{195m}Pt, ²²⁶Ra(γ,n)²²⁵Ra, ⁴⁸Ca(γ, n)⁴⁷Ca, ¹⁰⁴Pd(γ,n)¹⁰³Pd, ⁴⁶Ti(γ,2n)⁴⁴Ti, ⁶⁸Zn(γ,p)⁶⁷Cu, ⁶⁵Cu(γ,n)⁶⁴Cu, ¹⁶⁶Er(γ,n)¹⁶⁵Er, ¹⁷⁰Er(γ,n)¹⁶⁹Er, ⁴⁸Ti(γ,p)⁴⁷Sc, ¹⁸⁷Re(γ,n)¹⁸⁶Re, ²²⁶Ra(γ,2n)²²⁴Ra, ¹¹⁷Sn(γ,γ′)^{117m}Sn, ⁸⁷Sr(γ,γ′)^{87m}Sr, ¹¹⁵In(γ,γ′)^{115m}In, ¹¹⁹Sn(γ,γ′)^{119m}Sn, ¹²³Te(γ,γ′)^{123m}Te, ¹²⁵Te(γ,γ′)^{125m}Te, ¹²⁹Xe(γ,γ′)^{129m}Xe, ¹³¹Xe(γ,γ′)^{131m}Xe, ¹³⁵Ba(γ,γ′)^{135m}Ba, ¹⁷⁶Lu(γ,γ′)^{176m}Lu, ¹⁸⁰Hf(γ,γ′)^{180m}Hf, ¹⁹³Ir(γ,γ′)^{193m}Ir, ⁵²Cr(γ,n)⁵¹Cr, ⁵⁶Fe(γ,n)⁵⁵Fe, ⁷²Ge(γ,n)⁷¹Ge, ⁷⁶Se(γ,n)⁷⁵Se, ⁸⁶Sr(γ,n)⁸⁵Sr, ⁹⁸Ru(γ,n)⁹⁷Ru, ¹⁰⁸Cd(γ,n)¹⁰⁷Cd, ¹¹⁰Cd(γ,n)¹⁰⁹Cd, ¹¹⁴Sn(γ,n)¹¹³Sn, ¹²²Te(γ,n)¹²¹Te, ¹²²Te(γ,n)^{121m}Te, ¹²⁸Xe(γ,n)¹²⁷Xe, ¹³⁴Ba(γ,n)¹³³Ba, ¹³⁴Ba(γ,n)^{133m}Ba, ¹⁴⁰Ce(γ,n)¹³⁹Ce, ¹⁵⁴Gd(γ,n)¹⁵³Gd, ¹⁶⁰Dy(γ,n)¹⁵⁹Dy, ¹⁷⁰Yb(γ,n)¹⁶⁹Yb, ¹⁷⁶Hf(γ,n)¹⁷⁵Hf, ¹⁸²W(γ,n)¹⁸¹W, ¹⁹²Pt(γ,n)¹⁹¹Pt, ¹⁹⁴Pt(γ,n)^{193m}Pt, ⁷⁰Ge(γ,2n)⁶⁸Ge, ⁸⁴Sr(γ,2n)⁸²Sr, ¹⁴²Nd(γ,2n)⁸²Sr, ¹⁴²Nd(γ,2n)¹⁴⁰Nd.

These target isotopes A can be efficiently transmuted by a gamma-induced nuclear reaction to the desired product isotopes B. The high flux density of Compton back-scattered gamma beams thus leads to a high specific activity and the high flux of such gamma beams leads to a high activity per irradiation time. Moreover, some of the radionuclides which can be produced by gamma beam irradiation of these materials are especially useful for medical applications. Details on the advantages of producing these isotopes with Compton back-scattered gamma beams and on the medical use of these isotopes will be described in more detail below.

In a preferred embodiment, providing the γ beam further comprises controlling the γ beam. In particular, controlling the γ beam may comprise monitoring the γ beam energy and the γ beam energy bandwidth, and adjusting the electron beam in accordance with a result of the monitoring by feedback control. In more detail, deviations in the γ beam energy and the γ beam energy bandwidth from a set value can be detected, and the γ beam can then be tuned to steer against such deviations. Again, this leads to an increased induction of the desired nuclear reaction and helps to prevent undesired reactions.

In this embodiment, more preferably, the step of monitoring comprises sending a second γ beam from a γ beam production station being at least partially arranged in the electron beam to a dedicated second target, thereby releasing neutrons from the dedicated second target, and measuring the released neutron energy. Most preferably, the step of monitoring further comprises measuring the neutron energy by time-of-flight.

The specified approach provides a convenient and precise way of monitoring the γ beam online. Here, a second γ beam is used which may be produced similarly to the γ beam used for the production of the desired radionuclide. In particular, the second γ beam may be generated using laser light of the same or a different wavelength as the laser light for producing the γ beam for the actual production of the desired radionuclide B. The second γ beam is then used to induce a nuclear reaction on a second target. The dedicated second target is chosen so as to release neutrons upon irradiation by the second γ beam. Preferably, the second target is chosen such that the energy of the released neutrons is within the eV to kV range. In particular, measuring the neutron energy by time-of-flight and adding the neutron binding energy of the target provides an accurate on-line measurement of the second gamma beam which in turn is a measure of the electron beam energy and electron beam energy spread. From the electron beam energy/energy spread, the energy/energy spread of the main gamma beam used for isotope production can be discerned. In particular, the γ-beam energy can be stabilized e.g. for (γ,γ′) excitations.

Another way for monitoring the γ beam, which is also preferred and which can be employed additionally or alternatively, comprises providing a crystal in the γ beam, such that a portion of the γ beam (5) experiences Bragg diffraction. Moreover, it comprises placing a γ beam detector for measuring a Bragg angle of the Bragg diffracted portion of the γ beam.

In particular, a thin crystal comprising, e.g., Si, Ge, etc. can be placed in front, inside or behind the target. It can e.g. be arranged in a stacked arrangement with the target. A small fraction of the γ beam will be diffracted by the crystal according to the Bragg condition. Moreover, a γ ray detector is placed at a suitable distance allowing measuring the Bragg angle. The detector preferably has a narrow collimator and/or is position-sensitive. The crystal is provided with a known crystal lattice spacing. Further, the method comprises deducing the γ beam energy. By sensing the angular spread of the diffracted beam, the energy spread of the γ-beam is monitored. These data can be used for on-line tuning and monitoring of the γ beam production. The tuning in particular comprises tuning parameters of the electron beam like electron beam energy, pulse width, etc.

Preferably, the method further comprises at least one step of coupling an amount of radionuclide B with a molecule such as to form a bioconjugate.

For medical purposes, radioisotopes are most effective when moved to the desired spot in the human body. When using the isotope for treating cancer, it is desirable to bring the isotope material directly to the affected part of the body. This way, undesired treatment of body parts that are not affected is avoided. Moreover, for diagnostic purposes, it is desirable to acquire an image of specific body parts. For both purposes, it is desirable to couple the radioactive isotope to a substance that has a high affinity to the body part of interest. The result of this coupling are e.g. bioconjugates that show a high affinity to some target body part and for example selectively bind to cancer cells. By means of the bioconjugate, the isotope is transported to the desired location in the human body as described in more detail below. The production of such radioactive bioconjugate is an example of the above-mentioned radiopharmaceutical step.

In a preferred embodiment, the method further comprises storing the irradiated target for a period of time allowing the radionuclide product B to decay into a radionuclide end-product C. In particular, A, B, C may be selected from a group comprising ²²⁶Ra, ²²⁵Ra, ²²⁵ Ac and ⁴⁸Ca, ⁴⁷Ca, ⁴⁷Sc. The relevant nuclear reactions then comprise ²²⁶Ra(γ,n)²²⁵Ra(β⁻)²²⁵ Ac and ⁴⁸Ca(γ, n)⁴⁷Ca(β⁻)⁴⁷Sc, respectively. More generally, A, B and C may be selected such that the decay of B into C comprises a β⁻ decay or an α decay.

In particular, the period of time may be between 0.01 and 20 times the half-life T_{1/2} of radionuclide product B, preferably between 0.05 and 10 times the half-life T_{1/2} and most preferably between 0.1 and 3 times the half-life T_{1/2}.

This period of time allows for the production of a suitable amount of radionuclide C.

In a preferred embodiment, the method further comprises chemically separating the radionuclide product B or the radionuclide end product C, respectively, from the target and wherein, even more preferred, the step of separating is repeated several times. The product B or the radionuclide end product C is, in particular, separated from other substances present in the target. In even more detail, the product B or the radionuclide end product C, respectively, is separated from amounts of nuclide A present in the target after irradiating and/or storing. This separation is an example of the above-mentioned radiochemical step.

This allows producing the product B or the end product C with high purity.

In a preferred embodiment, the method further comprises the steps of providing n targets, each comprising an amount of a respective nuclide Aⁱ, wherein the nuclides Aⁱ are identical or different, positioning the n targets in a row one behind the other along the direction of the gamma beam, irradiating the targets, thereby transmuting at least a portion of the amount of each nuclide Aⁱ into the respective radionuclide product Bⁱ, wherein i is an integer between 1 and n and n is preferably between 2 and 1000, preferably between 10 and 100.

Placing multiple targets one behind each other with respect to the irradiating gamma beam, the gamma beam can be used more efficiently. Due to the high intensity and low opening angle of the gamma beam resulting from Compton back-scattering, some photons pass the first target without inducing any nuclear reactions. These photons can then be used to irradiate another target. This way, a higher percentage of the photons are used for desired conversion reactions.

Generally, each nuclide Aⁱ is selected based on the desired product Bⁱ as described above. Moreover, the nuclides Aⁱ can be identical or different. In particular, each nuclide Aⁱ can comprise any of the nuclides listed above. Moreover, the irradiation time of each target can be chosen to be identical or different. In addition, the nuclides Aⁱ may be the same to produce more of the same product, or may be different target isotopes to produce simultaneously different product isotopes.

In a preferred embodiment, one or more of the n targets consist of foil targets or thin wire targets. Foil targets or thin wire targets can also be used if there is only a single target.

This allows for a fast escape of Compton electrons or electron-positrons from pair creation, resulting in a reduced energy deposition and heating.

In a preferred embodiment, one or more of the n targets is present in a liquid form, preferably in aqueous solution. In embodiments, in which only one target is used, the one target may be present in liquid form.

Providing the target in liquid form is, in particular, advantageous for γ beams with low flux density. In embodiments with more than one target, it is, moreover, advantageous to provide targets in liquid form that are located downstream with respect to the γ beam. This way, the γ beam can be used more efficiently.

It further has the advantage that a subsequent radio chemical separation step is facilitated as the target does not need to be dissolved before processing. Moreover, after extraction of the product isotope the remaining solution of target nuclide can be easily recycled for an additional irradiation step.

According to a preferred embodiment, the target comprises an implantable product, wherein the implantable product preferably comprises a stent, a seed, a biodegradable implant, micro- or nanoparticles, and wherein the implantable product is most preferably adapted for brachytherapy or radioembolization applications.

Generally, an implantable product is to be understood as a medical product which is configured to be implanted into a human or an animal for the purpose of treatment. Irradiation of the implantable product allows for production of various products which can easily be applied to a patient. The radionuclide B can hence easily be transferred to the desired spot in the patient.

In a second aspect, the above problem is solved by providing an apparatus adapted for producing a radionuclide product B, the apparatus comprising: an electron accelerator for providing the electron beam, a laser light source for providing the laser light, means for performing Compton back-scattering of the laser light from the electron beam for generating the gamma beam, means for holding or receiving the nuclide A, such that the nuclide A is at least partially positioned within the gamma beam.

In a preferred embodiment, the electron accelerator is adapted to provide the electron beam with at least one adjustable parameter, wherein the at least one parameter preferably comprises an electron beam energy and/or an electron beam energy bandwidth.

This allows to tune the gamma beam to the desired energy and the desired energy bandwidth, such as to enhance the desired nuclear reaction and to suppress the production of undesired by-products.

In a preferred embodiment, the apparatus further comprises a system for monitoring the gamma beam, wherein the system preferably comprises a γ beam production station being at least partially arranged in the electron beam and further being adapted to generate a second γ beam, a second target adapted to release neutrons upon irradiation by the second gamma beam, and means for measuring the energy of neutrons released by the second target.

In a preferred embodiment the system alternatively or additionally comprises a crystal placed in the γ beam, such that a portion of the γ beam is diffracted by the crystal according to the Bragg condition, a γ ray detector, most preferably with narrow collimator and/or being position-sensitive, at a suitable distance for allowing to measure the Bragg angle.

As outlined above, this provides a precise and convenient method for monitoring the gamma beam.

According to a preferred embodiment, the apparatus further comprises at least one additional laser light source for providing at least one additional laser light beam and additional means for performing Compton back-scattering of the at least one additional laser light beam from the electron beam for generating at least one additional γ beam. The apparatus of this embodiment further comprises additional means for holding or receiving at least one additional target such that when held or received, each of the at least one additional targets is at least partially positioned within the at least one additional γ beam, respectively.

This allows for the generation of multiple γ beams from one electron beam. The electron beam can hence be used more efficiently. Moreover, a more convenient distribution of the positions, at which the γ beams are generated, along the electron beam path is achieved.

It is even more preferred that the laser light beam and the at least one additional laser light beam have different wave lengths.

The use of multiple laser light beams with different wave-lengths facilitates the induction of different nuclear reactions. Hence, different radionuclides can be produced simultaneously with the same electron beam.

In a preferred embodiment, the apparatus further comprises an irradiation chamber, wherein the irradiation chamber has means for receiving two or more targets aligned along a direction of the γ beam.

This allows for simultaneous irradiation of more than one target as outlined above.

In a preferred embodiment, the irradiation chamber is adapted to contain the one or more targets and is adapted to contain a vacuum, a gas, preferably helium, or a liquid, preferentially water, wherein the irradiation chamber preferably comprises inlet and outlet means for a gas or a liquid, and even more preferably comprises means for generating a gas or a liquid flow in the irradiation chamber.

In a preferred embodiment, the radiation chamber contains at least one of the one or more targets in liquid form, preferably in aqueous solution.

As argued above, this is in particular advantageous for γ beams with low flux density or for downstream targets in a multi-target arrangement.

This allows for an efficient heat removal from the one or more targets. Using a vacuum, moreover, in particular prevents unwanted reactions with substances in the air or otherwise present.

In third aspect of the invention, a method for producing ^{195m}Pt is Pt provided comprising the steps of providing a target comprising an amount of ¹⁹⁵Pt, and providing a gamma beam. The method further comprises irradiating the target by the gamma beam, thereby transmuting at least a portion of the amount of ¹⁹⁵Pt into ^{195m}Pt. Moreover, providing the gamma beam comprises providing a gamma beam by Compton back-scattering of laser light from an electron beam.

This provides a method for producing ^{195m}Pt with high specific activity. This ^{195m}Pt with high specific activity can be used in medical and diagnostic applications. For example, it may be used to verify a patient's response to chemotherapy with platinum compounds before a complete treatment is performed. Herein the batch of radionuclide may comprise ^{195m}Pt, wherein the specific activity of the batch of ^{195m}Pt is larger than 0.1 GBq/mg, in particular between 0.5 and 1000 GBq/mg, preferably between 1 and 100 GBq/mg and, even more preferably, between 10 and 90 GBq/mg.

A favourable medical or diagnostic application of ^{195m}Pt with a high specific activity is as follows. It is well-known that platinum compounds such as cisplatin or carboplatin are cytotoxic and are frequently used for chemotherapy. However, the uptake of the platinum compounds by the tumor differs from patient to patient, which makes it difficult to determine the proper dose for the chemotherapy. In some cases, the chemotherapy may even be entirely ineffective due to a limited uptake of the platinum compound.

However, using ^{195m}Pt with the high specific activity as referred to above, which can be produced by the method of the invention for the first time, it is possible to use the ^{195m}Pt as a SPECT radiotracer allowing to investigate the uptake of platinum compound by the tumor. This can be used as a step of determining the proper dose for a chemotherapy or estimating the expected success of the chemotherapy.

Accordingly, a further aspect of the invention is related to the use of ^{195m}Pt as a radiopharmaceutical, and in particular as a radiotracer for a SPECT analysis, and in particular ^{195m}Pt as obtainable by the method of the invention, and/or ^{195m}Pt having a specific activity larger than 0.1 GBq/mg, in particular between 0.5 and 1000 GBq/mg, preferably between 1 and 100 GBq/mg and, even more preferably, between 10 and 90 GBq/mg.

Advantageously, ^{195m}Pt can also be used in combined chemo-radiation therapy. Here, a chemo-therapeutic marked with ^{195m}Pt of high activity can act simultaneously chemically and by irradiation and thus may destroy cancer cells which are resistant to chemotherapy or radiation therapy alone.

In a preferred embodiment of the method for treating patients, the batch of radionuclide may comprise ^{117m}Sn, wherein the specific activity of the batch of ^{117m}Sn is larger than 1 GBq/mg, in particular between 1 and 1000 GBq/mg, preferably between 2 and 100 GBq/mg and, even more preferably, between 3 and 90 GBq/mg.

In a preferred embodiment of the fourth aspect of the invention, the method further comprises detecting a distribution of the injected batch of the radionuclide in the patient and/or measuring a concentration of the injected batch of the radionuclide in the patient. This may comprise standard methods as PET and/or SPECT.

Further advantageous and details of the present invention are explained in the following description in conjunction with the attached figures.

### BRIEF DESCRIPTION OF THE DRAWINGS

FIG. 1 shows a schematic view of a setup for generating a gamma beam by Compton back-scattering of laser light from an electron beam.

FIG. 2 shows a schematic view of a setup similar to that of FIG. 1 using two target batches simultaneously.

FIG. 3 shows a schematic view of a multi-target arrangement.

FIG. 4a shows a schematic view of an apparatus for generating a gamma beam by Compton back-scattering of laser light from an electron beam comprising means for controlling and stabilizing the gamma beam.

FIG. 4b shows a schematic view of an apparatus similar to that of FIG. 4a and further comprising additional means for monitoring the γ beam.

FIG. 5 shows a diagrammatic view of the bandwidths of high-energy gamma beams (˜10 MeV) as a function of time.

FIG. 6 shows the peak brilliance of high-energy γ beams scaled to 10 MeV as a function of time.

FIG. 7 shows the measured photonuclear cross section for ¹⁶⁰Gd and the maximum Breit-Wigner resonance cross section λ²/(4π). The threshold values for the reactions are indicated by arrows.

FIG. 8 shows a schematic view of a single refractive γ-lens.

FIG. 9 shows a schematic view of a stack of three refractive γ-lenses.

### DESCRIPTION OF PREFERRED EMBODIMENTS

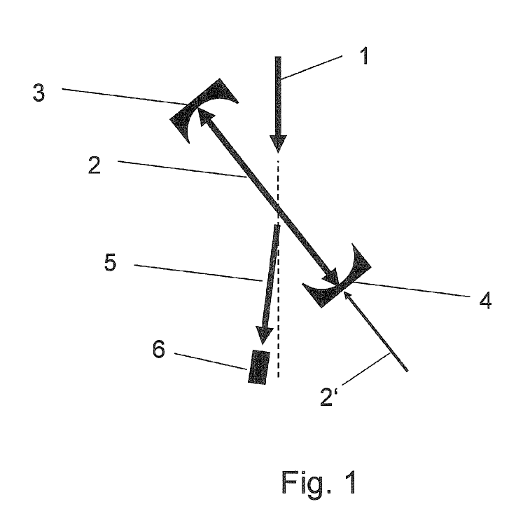

In FIG. 1, a setup for generating a gamma (γ) beam by means of Compton back-scattering of laser light from an electron beam is shown schematically. An electron beam 1 is provided. Also, laser pulses 2′ are generated, which are provided at an angle relative to the direction of the electron beam 1. The laser pulse 2′ is produced by standard means and injected in the space between two mirrors 3, 4, between which the laser pulse 2 is reflected repeatedly. When the laser pulse 2 hits the electron beam 1, a gamma beam 5 is generated by Compton back-scattering of the laser pulse 2 at the electron beam 1. Also shown in FIG. 1 is the target 6, which comprises the starting material A.

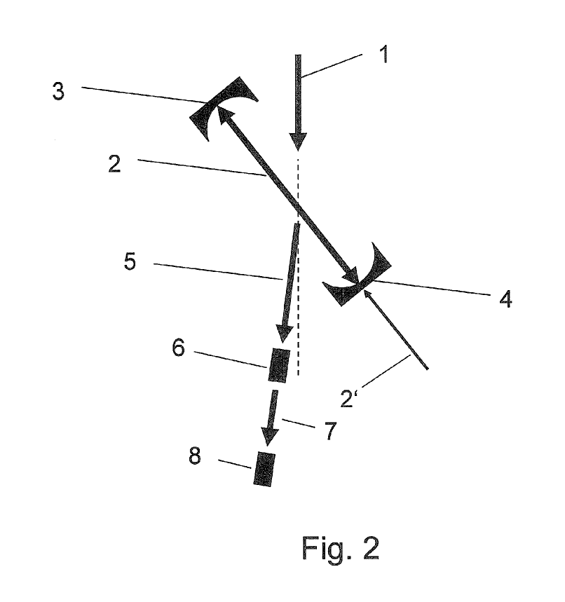

FIG. 2 shows a similar setup for producing radionuclides. The setup is similar to that of FIG. 1, except that a second target 8 is positioned behind the target 6 in propagation direction of gamma beam 5. Hence, the gamma beam 5 first hits the target 6. As the gamma beam has high intensity and low beam spot size, some of the γ quanta pass through the target 6 without inducing any nuclear reaction. Subsequently, these γ quanta leave target 6 and form gamma beam 7 hitting the second target 8 and inducing nuclear reactions therein, such that the material comprised in the target 8 is converted.

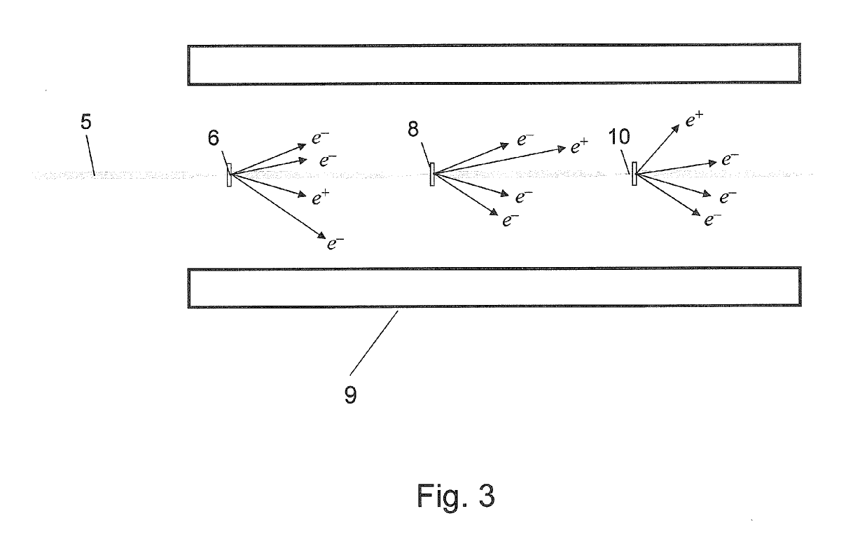

FIG. 3 shows another similar setup. Herein three targets 6, 8, 10 are irradiated by the gamma beam 5. The targets 6, 8, 10 are aligned along the direction of the gamma beam. As schematically shown in FIG. 3, from each target 6, 8, 10, a number of reaction products like Compton electrons emerge upon irradiation. These products emerge at different angles with respect to the axis of gamma beam 5. In order to keep the reaction product from entering the next target 8, 10 in line, the targets 6, 8, 10 are sufficiently spaced apart. The setup further comprises an envelope 9. The envelope 9 is used to cool the targets and to stop the reaction products emerging from the targets 6, 8, 10. In additional embodiments, the envelope may be water cooled.

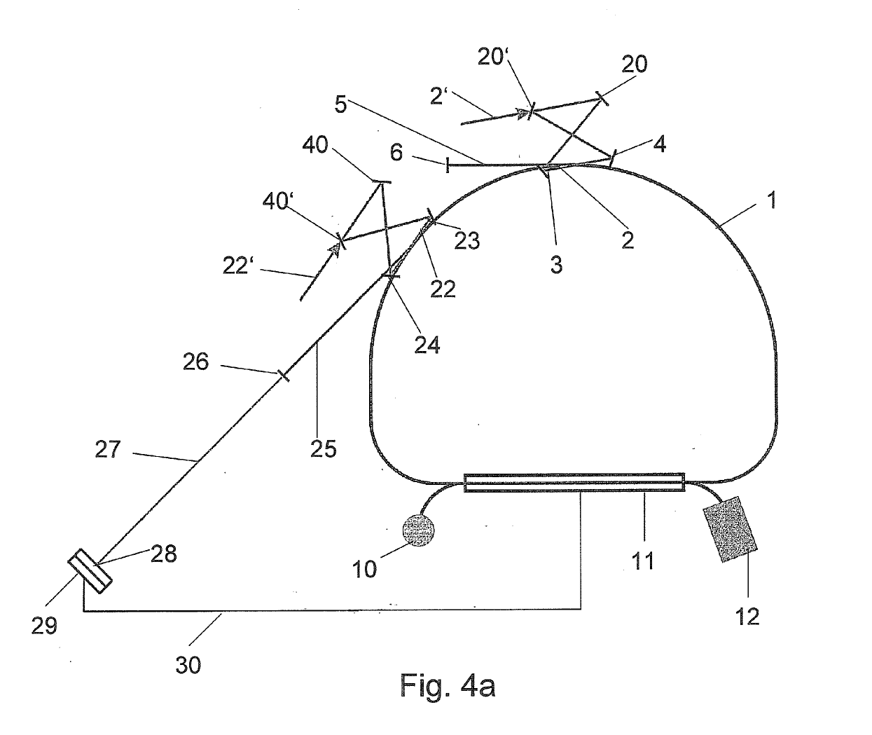

FIG. 4a shows an apparatus for providing a gamma beam 5. The apparatus in FIG. 4a, moreover, comprises means for monitoring and stabilizing the gamma beam 5.

The apparatus comprises an electron source 10, an electron energy recovery linac (ERL) 11 and a beam dump 12. Electrons are generated by the electron source 10 and injected into the electron ERL 11. Here, the electrons are formed into an electron beam 1. The electron beam 1 passes one circulation before being dumped into the beam dump 12. The beam dump 12 is arranged behind the electron ERL 11.

In the apparatus shown in FIG. 4a, two stations for generating gamma beams are present. In other embodiments, more than two stations for generating gamma beams can be present, being aligned along the electron beam path.

In a first station, a laser pulse 2′ is provided and is led via auxiliary mirrors 20, 20′ into the space between two mirrors 3, 4. As shown in FIG. 4a, the mirrors 3, 4, 20, 20′ are arranged to reflect the laser pulse 2 repeatedly. First, the laser pulse 2′ enters the mirror setup via auxiliary mirror 20′. The laser pulse passes to auxiliary mirror 20, where it is reflected to mirror 3. From there, the laser pulse 2 is reflected to mirror 4, where it is reflected back to auxiliary mirror 20′. Due to this closed-loop setup, the laser pulse 2 repeatedly passes the distance between mirrors 3 and 4. Here, also the electron beam 1 passes. The laser pulse 2 path and the electron beam 1 path cross at an angle of little less than 180°. By reflecting the laser pulse 2 through the distance between mirrors 3 and 4 repeatedly, chances of collision between the laser pulse 2 and the electron beam 1 are increased. When the laser pulse 2 collides with the electron beam 1, Compton-backscattering may occur, generating a high intensity gamma beam 5. The setup, moreover, comprises a target 6 for producing the radionuclide B.

In order to monitor and, in particular, to stabilize the gamma beam 5, a second station is provided in the apparatus of FIG. 4a. The second station comprises generating means for a second laser pulse 22′, entering a mirror setup via auxiliary mirror 40′. The laser pulse then hits auxiliary mirror 40, where it is reflected to mirror 24. From mirror 24, the laser pulse 22 is reflected to mirror 23, reflecting the laser pulse back to auxiliary mirror 40′. Similar to the first station, the mirrors 23, 24 and the auxiliary mirrors 40, 40′ are arranged in a closed-loop configuration.

The mirrors 23, 24 are arranged such that electron beam 1 passes the distance between the mirrors 23 and 24. When the laser pulse 22 hits the electron beam 1, a second high-intensity gamma beam 25 is generated. A dedicated second target 26 is arranged along the direction of the second gamma beam 25. The second target 26 is chosen as to release neutrons 27 upon radiation by the second gamma beam 25. Moreover, the apparatus comprises a detector setup having a converter target 28 and a detector 29. In this embodiment, the converter target 28 is a uranium converter target and the detector 29 comprises a pixeled scintillation detector. However, in other embodiments, other types of converter targets and/or detectors may be used. The converter target 28 is placed immediately before the detector 29. The detector setup, moreover, is arranged behind the second target 26 in the direction of the second gamma beam 25. The neutrons 27 being released from the dedicated second target 26 move towards the detector setup. The detector setup is arranged such as to measure the energy of the released neutrons 27 by time-of-flight. Adding the neutron binding energy of the second target 26 to the measured neutron 27 energy then provides an accurate online measurement of the second gamma beam 25 energy and energy spread. These, in turn, are indicative of the electron beam 1 energy and electron beam 1 energy spread. This, in turn, indicates the energy and energy spread of the gamma beam 5 used for radionuclide production.

The apparatus of FIG. 4a moreover comprises a feedback signal lead 30. The measured results of the detector setup comprising the detector 29 are fed back to the electron ERL 11 such as to adjust electron beam parameters based on the measurement results. In particular, the electron beam 1 energy provided by the electron ERL 11 is controlled based on the feedback signal from the detector 29. In more detail, should the neutron 27 energy measured by the detector 29 be below a predetermined reference value, the electron ERL 11 will increase the electron beam 1 energy. Vice versa, should the measured neutron 27 energy be above a predetermined reference value, the electron ERL 11 will decrease the electron beam 1 energy. Adjusting the electron beam 1 energy also modifies the gamma beam energy. This way, the electron beam 1 may be stabilized, and, consequently also the gamma beam 5 may be stabilized.

Similarly, also the neutron 27 energy spread can be detected by the detector setup comprising the detector 29. The measured neutron 27 energy spread is indicative of the second gamma beam 25 energy spread, which, in turn, indicates an electron beam 1 energy spread and, consequently, also the gamma beam 5 energy spread. The apparatus of FIG. 4a thus also allows to monitor and stabilize the gamma beam 5 energy spread.

FIG. 4b shows a setup which is similar to that of FIG. 4a. The apparatus shown in FIG. 4b furthermore comprises an additional assembly positioned behind the target 6 in the direction of the γ beam 5. Here, a crystal 50 is positioned behind the target 6, such that a portion of the γ beam 5 passing through the target 6 hits the crystal 50. Here, the γ beam 5 is diffracted by the crystal 50 resulting in a diffracted γ beam 52. The diffracted γ beam 52 and the original γ beam 5 enclose an angle denoted by θ. The apparatus shown in FIG. 4b further comprises a collimator 54. The diffracted γ beam 52 passes through the collimator 54 and hits a second crystal 51. The second crystal 51 is positioned behind the collimator 54 in the direction of the diffracted γ beam 52. Hitting the second crystal 51, the diffracted γ beam 52 is diffracted again. The apparatus further comprises a position sensitive detector 53 which is placed behind the second crystal 51.

The apparatus shown in FIG. 4b allows for an additional monitoring of the γ beam. Here, a portion of the γ beam 5 used for production of the target isotope is directly used for monitoring purposes. In an alternative embodiment, the position sensitive detector is coupled to the energy recovery linac via an additional feed back signal lead for improved controlling of the electron beam.

While not shown in FIGS. 1 to 4b, a refractive γ-lens may be employed for focussing the γ-beam onto the target 6, thereby further increasing the γ-flux in the target region.

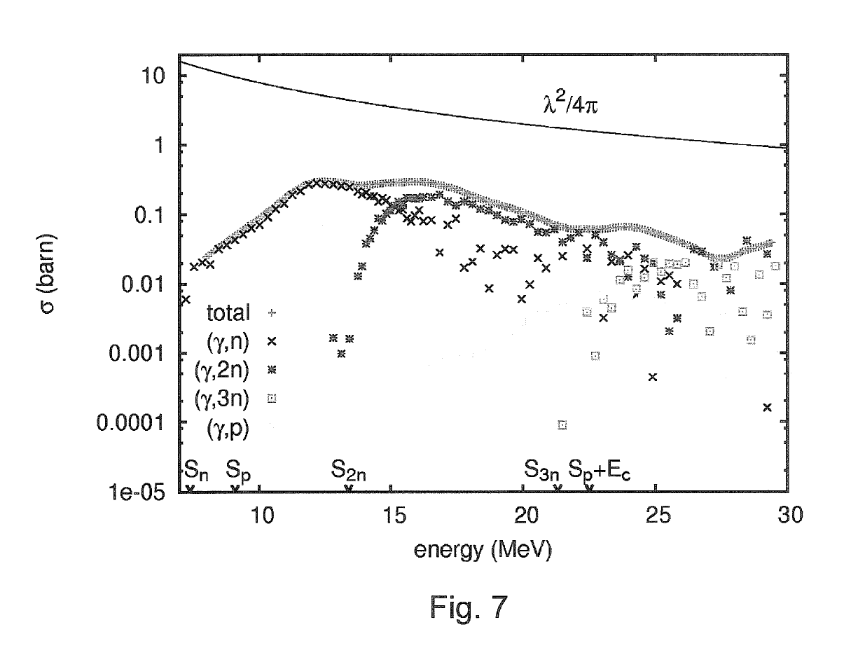

In FIG. 8, a schematic view of a single refractive γ-lens 80 is shown. With regard to visible light, it is known that a refractive focusing lens has a convex profile, since the index of refraction is larger than unity. However, for gamma photons in matter, the index of refraction is actually slightly smaller than unity, such that a focusing refractive γ-lens will have a concave shape. A single lens has two parabolic surfaces 81 to avoid spherical aberrations. The incident gamma ray 82 is refracted when passing through the surfaces of parabolas.

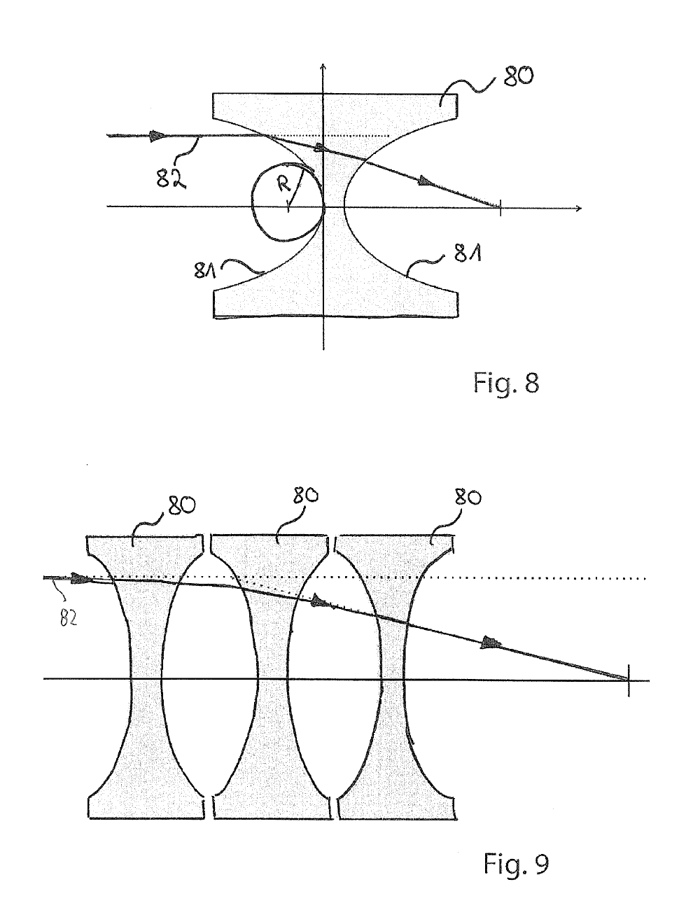

In FIG. 9, a stack of three single refractive lenses 80 is shown. Since the index of refraction of gamma rays in matter is very close to unity, a large number, typically 1,000 to 5,000 of single lenses are required to increase the total refraction power. The refraction of each (single) lens increases as the radius of curvature R (as shown in FIG. 8) decreases. The radius of curvature at the parabola's apex typically lies between R=2 mm down to a few micrometers only. Refractive γ-lenses may generally be made from different materials, such as beryllium, aluminium, nickel, silicon or diamond. A preferred way of fabricating arrays of refractive γ-lenses is to use silicon and employ highly developed industrial nano-structuring techniques that are available in the art.

### Medical Applications

The invention is most advantageous for the production of radioisotopes for nuclear medicine in (γ, xn+yp+zy′) reactions with high flux ((10¹³-10¹⁵)γ/s), small diameter (˜(100 μm)²) and small band width (ΔE/E=10⁻³-10⁻⁴) gamma beams produced by Compton back-scattering of laser light from relativistic brilliant electron beams. This method has, in particular, advantages over (ion, xn+yp) reactions, where the “ion” could be p, d or a particles from particle accelerators like cyclotrons and (n, γ) or (n,f) reactions from nuclear reactors. For photonuclear reactions with a narrow γ beam, the energy deposition in the target can be managed by using a stack of thin target foils or target wires, hence avoiding direct stopping of the Compton and pair electrons/positrons. However, for ions with a strong atomic stopping only a fraction of less than 10⁻² leads to nuclear reactions resulting in a target heating, which is at least 10⁵ times larger and often limits the achievable specific activity. In photonuclear reactions the well defined initial excitation energy of the compound nucleus leads to a small number of reaction channels with new combinations of target isotope and final radioisotope. The narrow bandwidth γ excitation may make use of the fine structure of the Pygmy Dipole Resonance (PDR) or fluctuations in γ-width leading to increased cross sections. Within a rather short period compared to the isotopic half-life, a target area on the order of 100 μm² can be highly transmuted, resulting in a very high specific activity. (γ,γ′) isomer production via specially selected γ cascades allows to produce high specific activity in multiple excitations, where no back-pumping of the isomer to the ground state occurs. We discuss in detail many specific radioisotopes for diagnostics and therapy applications. Photonuclear reactions may allow to produce certain radioisotopes with higher specific activity more economically.

### Nuclear Medicine

In nuclear medicine radioisotopes are used for both diagnostic and therapeutic purposes. Many diagnostics applications are based on molecular imaging methods, i.e. either on positron emitters for 3D imaging with PET (positron emission tomography) or gamma ray emitters for 2D imaging with planar gamma cameras or 3D imaging with SPECT (single photon emission computer tomography). The main advantage of nuclear medicine methods is the high sensitivity of the detection systems that allows using tracers at extremely low concentrations (some pmol in total, injected in typical concentrations of nmol/l). This extremely low amount of radiotracers assures that they do not show any (bio-)chemical effect on the organism. Thus, the diagnostic procedure does not interfere with the normal body functions and provides direct information on the normal body function which is not perturbed by the detection method. Moreover, even elements that would be chemically toxic in much higher concentrations can be safely used as radiotracers (e.g. thallium, arsenic, etc.). To maintain these intrinsic advantages of nuclear medicine diagnostics one has to assure that radiotracers of high specific activity are used, i.e. that the injected radiotracer is not accompanied by too much stable isotopes of the same (or a chemically similar) element. In this regard, the present invention is particularly useful, as the radionuclide B can be produced with high specific activity.

Radioisotopes are also used for therapeutic applications, in particular for endo-radiotherapy. Targeted systemic therapies allow fighting diseases that are non-localized, e.g. leukaemia and other cancer types in an advanced state when already multiple metastases have been created. Usually a bioconjugate is used that shows a high affinity and selectivity to bind to cancer cells. Combining such a bioconjugate with a suitable radioisotope such as a (low-energy) electron or alpha emitter allows to selectively irradiate and destroy the cancer cells. Depending on the nature of the bioconjugate, these therapies are called Peptide Receptor Radio Therapy (PRRT) when peptides are used as bioconjugates or radioimmunotherapy (RIT) when antibodies are used as bioconjugates. Bioconjugates could also be antibody-fragments, nanoparticles, microparticles, etc. For cancer cells having only a limited number of selective binding sites, an increase of the concentration of the bioconjugates may lead to blocking of these sites and, hence, to a reduction in selectivity. Therefore the radioisotopes for labelling of the bioconjugates should have a high specific activity to minimize injection of bioconjugates labelled with stable isotopes that do not show radiotherapeutic efficiency. Thus often high specific activities are required for radioisotopes used in such therapies.

The tumor uptake of bioconjugates varies considerably from one patient to another. This leads to an important variation in dose delivered to the tumour if the same activity (or activity per body mass or activity per body surface) was administered. Ideally a personalized dosimetry should be performed by first injecting a small quantity of the bioconjugate in question, marked by an imaging isotope (preferentially (3+ emitter for PET). Thus the tumor uptake can be quantitatively determined and the injected activity of the therapy isotope can be adapted accordingly. To assure representative in-vivo behaviour of the imaging agent the PET tracer should be ideally an isotope of the same element as the therapy isotope, or, at least of a chemically very similar element such as neighbouring lanthanides. Thus so-called “matched pairs” of diagnostic and therapy isotopes are of particular interest: ^{44(m)}Sc/⁴⁷Sc, ⁶¹Cu or ⁶⁴Cu/⁶⁷Cu, ⁸⁶Y/⁹⁰Y, ¹²³I or ¹²⁴I/¹³¹I or ¹⁵²Tb/¹⁴⁹Tb or ¹⁶¹Tb. Often the production of one of these isotopes is less straightforward with classical methods. Therefore “matched pairs” are not yet established as standard in clinical practice. The present invention allows for wide-spread implementation of this method.

### Presently Used Nuclear Reactions to Produce Medical Radioisotopes

Today the most frequently employed nuclear reactions for the production of medical radioisotopes are as follows.

### Neutron Capture in Nuclear Reactors

Neutron capture (n, γ) reactions transmute a stable isotope into a radioactive isotope of the same element. High specific activities are obtained if the (n, γ) cross section is high and the target is irradiated in a high neutron flux. Neutrons most useful for (n, γ) reactions have energies from meV to keV (thermal and epithermal neutrons) and are provided in the irradiation positions of high flux reactors at flux densities of several 10¹⁴ n/(cm² s), up to few 10¹⁵ n/(cm² s). If the neutron capture cross section is sufficiently high, then a good fraction of the target atoms can be transmuted to the desired product isotopes, resulting in a product of high specific activity.

High specific activities can also be achieved by using indirect production paths. The (n, γ) reaction is not populating directly the final product but a precursor that decays by beta decay to the final product. Thus the final product differs in its chemical properties from the target and can be chemically separated from the bulk of the remaining target material.

### Nuclear Fission

Fission is another process used for isotope production in nuclear reactors. Radiochemical separation leads to radioisotopes of “non-carrier-added” quality, with specific activity close to the theoretical maximum.

Charged Particle Reactions with p, d or α Ions

Imaging for diagnostic purposes requires either β⁺ emitters for PET, or isotopes emitting gamma-rays with suitable energy for SPECT (about 70 to 300 keV), if possible without β(+/−) emission to minimize the dose to the patient. Thus electron capture decay is preferred for such applications. Usually, these neutron-deficient isotopes cannot be produced by neutron capture on a stable isotope, ⁶⁴Cu being an exception. Instead they are mainly produced by charged-particle induced reactions such as (p,n), (p,2n), . . . etc. High specific activities of the final product are achievable when the product differs in chemical properties from the target (i.e. different Z) and can be chemically separated from the remaining bulk of target material. Thus Z must be changed in the nuclear reaction, e.g. in (p,xn), (p,2n), (p, α) reactions. The energies of the charged particle beams for such reactions are usually in the range of 10 to 30 MeV and can be supplied with high currents (0.1 to 1 mA) by small cyclotrons.

### Generators

Another important technique is the use of generators, where short-lived radionuclides are extracted “on-tap” from longer-lived mother nuclides. Here the primary product isotope (that was produced in the nuclear reaction) has a longer half-life than the final radioisotope (that is populated by decay of the primary product isotope and is used in the medical application). The generator is loaded with the primary product isotope, then the final radioisotope can be repetitively eluted and used. For the extraction of the shorter-lived isotope chromatographic techniques, distillation or phase partitioning are used. Depending on the generator technology, there is usually a limit to which a generator can be loaded with atoms of the primary product element. If more is loaded, then a significant part of the primary product isotope might be eluted too, also referred to as “breakthrough”, leading to an inacceptable contamination of the product with long-lived activity. To prevent such problems, generators are generally loaded with material of a given minimum specific activity. Here, the present invention is, in particular, useful for producing the generator nuclide.

### (γ,n) Reactions

The inverse process to (n, γ), namely (γ,n) also allows producing neutron deficient isotopes, but conventional γ ray sources do not provide sufficient flux density for efficient production of radioisotopes with high total activity and high specific activity. Therefore this process plays no role in present radioisotope supply.

### Gamma Beams

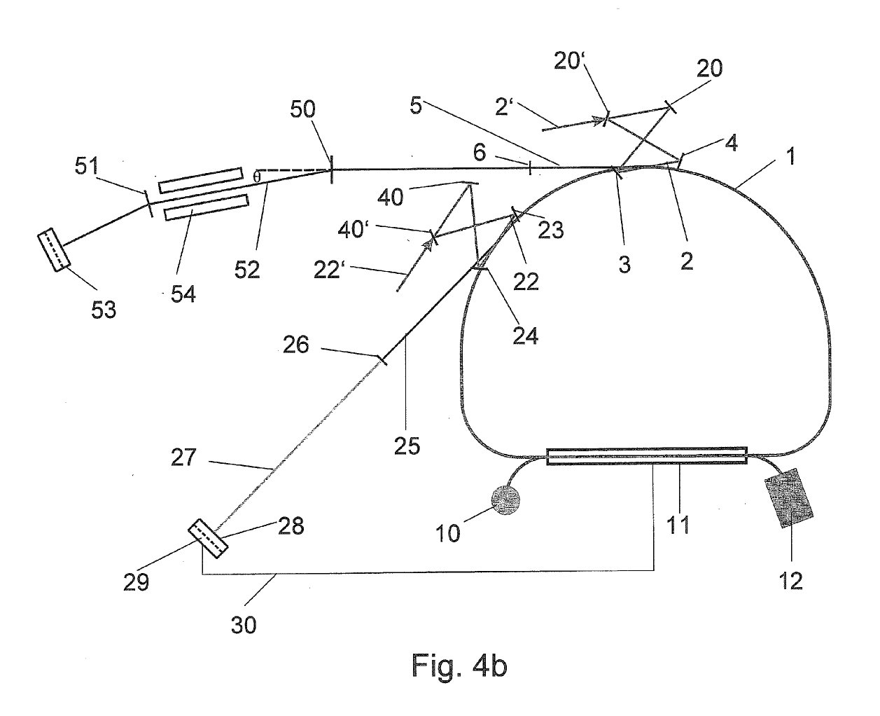

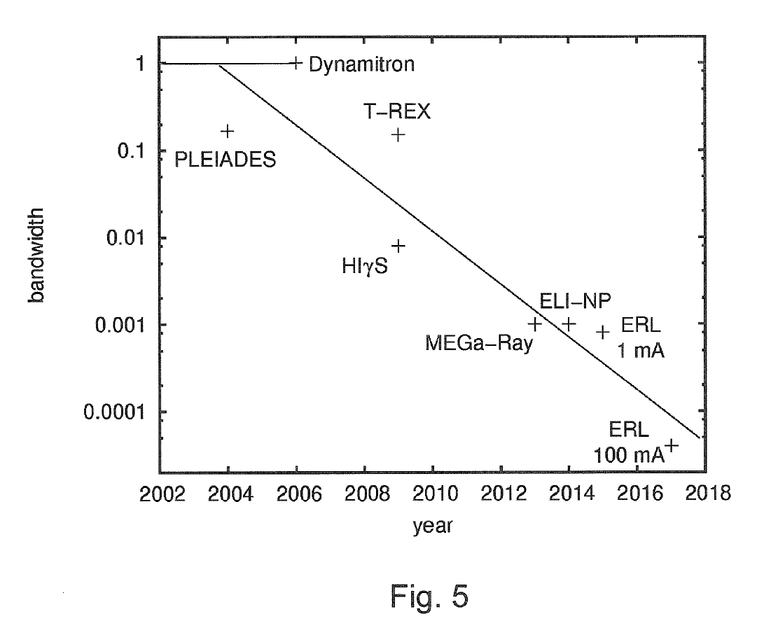

The new concept of isotope production with a gamma beam only became possible, because very brilliant γ sources are being developed, where the gamma beams are produced by incoherent Compton back-scattering of laser light from brilliant high-energy electron bunches. FIG. 5 and FIG. 6 show the rapid progress of gamma beam properties for the bandwidth (FIG. 5) and the peak brilliance (FIG. 6) with time, starting with the Bremsstrahlung spectrum of the Stuttgart Dynamitron, which still had a very large bandwidth.

For Compton back-scattering in a head-on collision the γ energy is given by:

$${E}_{γ} = \frac{4 {γ}_{e}^{2} {E}_{L}}{1 + {γ}_{e} {Θ}_{γ}^{2} + 4 {γ}_{e} {E}_{L} / {mc}^{2}} \qquad ( 1 )$$

with the γₑ factor, characterizing the energy of the electron beam, the γ energy E_{γ}, its angle Θ_{γ} and the laser photon energy E_{L}. The energy E_{g} decreases with ι_{γ}. A small bandwidth of the γ beam requires a small energy spread of the electron bunches Δγₑ/γₑ, a small bandwidth of the laser energy ΔE_{L}/E_{L}, a very good emittance of the electron beam with a small opening angle and small opening angle of the laser beam. At the HI γS facility (Duke University, USA) the photons are produced by an FEL and then are back-scattered from a circulating electron beam. They already produced high energy γ rays, but the flux was too weak for radioisotope production. C. Barty and his group at the Lawrence Livermore National Laboratory (LLNL) developed already three generations of incoherent Compton back-scattering sources: PLEIADES, T-REX and MEGa-Ray, each based on a “warm” electron LINAC and a fibre laser for back-scattering. Recently the electron LINAC technology was switched from S-band technology (4 GHz) for T-REX to X-band technology (12 GHz) for MEGa-Ray. The MEGa-Ray gamma beam runs with a macro pulse structure of 120 Hz using 1.5 J, 2 ps laser pulses, which are recirculated 100 times with 2 ns bunch spacing in a ring-down cavity. The group plans for lower energy γ rays in the range of a only few MeV, too small for photonuclear reactions. A similar γ facility is planned for the ELI-Nuclear Physics project (ELI-NP) in Romania, also based on a “warm” linac like the one used at MEGa-Ray, however designed for γ energies up to 19 MeV, thus reaching interesting intensities and γ energies for isotope production. R. Hajima and co-workers at Ibaraki (Japan) are developing a Compton back-scattering gamma beam using an energy recovery linac (ERL) and superconducting “cold” cavities. For smaller electron bunch charges very low normalized emittances of 0.1 mm mrad can be obtained from the electron gun. For the reflected laser light a high finesse enhancement cavity is used for recirculating the photons. The quality of the electron beam from the ERL can be preserved by running with higher repetition rate. Switching from a 1 mA electron current to a 100 mA current the peak brilliance and bandwidth can be improved significantly. Intensities of 5×10¹⁵ γ/s are expected.

Also laser-accelerated electron bunches have been proposed as relativistic mirrors for Compton back-scattering and the production of intense gamma beams and can be used in conjunction with the present invention.

The yield of resonant photonuclear reactions which are discussed below depends strongly on the exact energy and the band width of the γ beam. Both parameters are determined by the quality of the laser beam and of the electron beam. The laser beam parameters are usually well controlled by means that are conventionally used in laser spectroscopy. More importantly, the electron beam parameters need to be tuned and monitored with high precision. For an optimized monitoring system, the γ beam energy needs to be measured with a system that has a far better energy resolution than the γ beam itself. It is, however, not trivial to measure a high energy γ beam energy with such a high precision. For γ beams in the MeV range, conventional Ge detectors are limited to an energy resolution in the order of 10⁻³. Scintillation detectors, on the other hand, have an even worse energy resolution. Hence, more complex and less conventional methods are preferably used for this purpose. Here, two methods are particularly preferred:

### a) A Crystal Spectrometer:

A thin single or mosaic crystal, i.e. SiGe, SiO₂, CO, graphite, etc., is placed in the γ beam. The crystal may be placed in front, inside or behind the production target. A small portion of the γ beam will be diffracted by the crystal according to the Bragg condition. Placing a beam detection system at a large distance from the crystal allows measuring the diffraction angle either by scanning the beam through narrow collimators by turning the crystal or by using a fixed crystal and a detector with a high spatial resolution. Hence, the wavelength of the beam can be deduced which directly gives the beam energy. The angular spread of the diffracted beam is, moreover, a measure of the energy spread of the electron beam.

The deduced energy and energy spread can be used for a feedback system for tuning and monitoring the electron beam used for the γ beam production. Due to the high intensity of the γ beam, even with thin crystals and in high reflection order, enough photons will arrive at the detector. A higher reflection order is preferred, since it allows placing the detector further away from the original, non-diffracted beam. For γ beams having a larger opening angle, the latter would, however, limit the achievable energy resolution. Here, it is preferred to use two consecutive crystals for diffraction as outlined in FIG. 4b: a first crystal 50 is placed in the γ beam 5. The small intrinsic angular acceptance of the crystal 50 will effectively act as a collimator. A second crystal 51 therefore receives a well-collimated beam. An additional collimator 54 is placed between both crystals 50, 51 to eliminate γ beams of other diffraction orders. In further embodiments, a collimator is additionally or alternatively placed between the second crystal and the detector. Using two consecutive diffractions in the same direction will add to the energy dispersion and provide a very high energy resolution. Two diffractions in opposite directions, on the other hand, allow measuring the intrinsic resolution of the measurement system.

The rotation angle of the crystals is usually controlled by laser interferometers. Such a double crystal spectrometer enables measuring γ beam energies with a resolution below 10⁻⁶ and hence fully complies with the needs to stabilize the γ beam within the desired band width. More details on the layout, operation and performance of a suitable crystal spectrometer were described by M. S. Dewey et al., Phys. Ref. C 73 (2006), 044303 and references therein.

### b) A (γ,n) Threshold Reaction

Alternatively or additionally to a crystal spectrometer, also a second γ beam from a second γ beam production station can be used for monitoring the electron beam energy. The second γ beam may have a different wave length. The second γ beam is sent to a dedicated target where it induces (γ,n) reactions just above the threshold. Neutrons are released within the eV to keV range. Due to the pulsed nature of the γ beam, the neutron energy can be measured by time of flight with a good precision of a few eV or better. Adding the neutron energy to the well known neutron binding energy of the target then provides an accurate online measurement of the γ beam energy and the γ beam energy spread. These are also indicative of the electron beam energy and the electron beam energy spread. Again, this information is used for a feedback system to optimize and stabilize the electron accelerator parameters.

Neutron detection can be realized in various ways. One possibility is the use of a “neutron converter” combined with a charged particle detector. As neutron converter, different materials containing isotopes like e.g. ⁶Li, ¹⁰B or ²³⁵U may be used. The ¹⁰B(n,α)⁶Li reaction has a flat cross section which is about 6 barn at 10 keV, rising towards lower energies. Even boron loaded plastic scintillators like, e.g. BC-454 from Saint Gobain can be used. Also ²³⁵U is a good converter for neutrons of a few keV with a cross section of about 5 barn. Below 1 keV, there are stronger variations of the resonance cross sections of ²³⁵U(n,f). For 1 keV neutron energy and 100 ps timing resolution, the converter layer is preferably less than 50 μm thick. Using a segmented detector array, many neutrons may be measured per bunch allowing for a fast feedback system. The lengths of the neutron flight paths should be adjusted to the neutron energies, and may be several meters long.

### Specific Activity of Radioisotopes and Photonuclear Cross Sections

One of the most important quality criteria for radioisotopes for nuclear medicine applications is the specific activity (A/m), usually expressed in GBq/mg, Ci/mg or similar units. The necessary condition to reach high specific activities is:

$$σ \cdot Φ \approx \frac{ln 2}{{T}_{1 / 2}}$$

Radioisotopes for medical applications have typically half-lives of hours to days, hence the flux density Φ (in part./(cm² s)) should approach or exceed a value of about 10¹⁹/σ (in barn) where σ is the cross-section. For future planned γ beams with several 10¹⁵ γ/s, in particular 5·10¹⁵ γ/s over areas of (0.1 mm)², the flux density can reach several 10¹⁹ γ/(cm²s), i.e. the target can be efficiently transmuted by photonuclear reactions with cross sections of a few 100 mb.

For resonant reactions with higher cross sections, even the use of less powerful γ beam facilities with flux densities in the order of 10¹⁷ γ/(cm²s) will assure a relatively high specific activity of the product.

The finally reached specific activity is also determined by the undesired further transmutation (burnup) of the wanted reaction product. This product burnup becomes significant when the product fraction gets high. For (n, γ) reactions in high flux reactors it may eventually limit the achievable specific activity if the neutron capture cross-section of the product is high. For ¹⁵³Gd, ¹⁵⁹Dy, ¹⁶⁹Yb or ^{195m}Pt this seriously limits the achievable specific activity. In other cases the secondary product produced by a reaction on the primary desired product presents a disturbing radionuclide impurity.

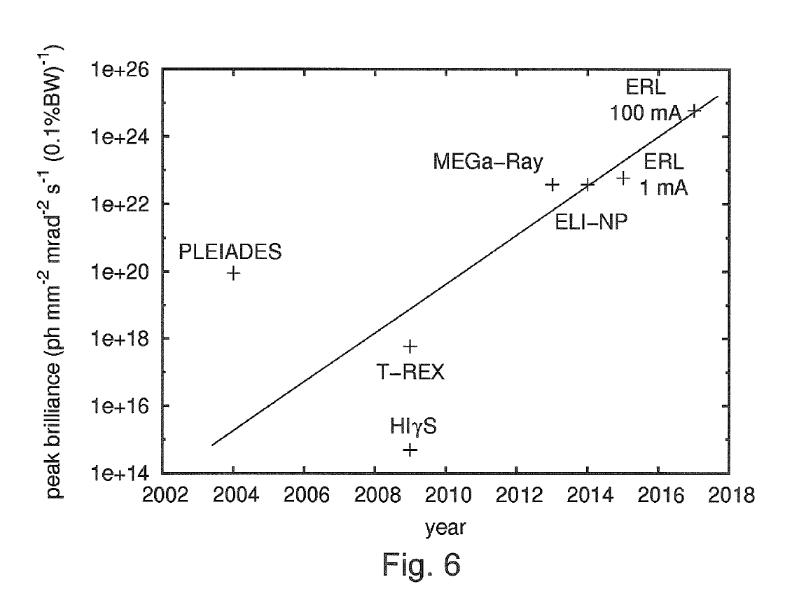

If one looks at measured photonuclear cross sections one typically finds cross sections below 1 barn. As a prototype we show in FIG. 7 the photonuclear cross sections for ¹⁶⁰Gd. The arrows with separation energies indicate the thresholds for the (γ, xn+yp) reactions. Close to threshold a transmission factor of the neutron and the proton reduces the cross section. The protons in addition have a reduction by a Coulomb tunnelling factor exp(−π(Z−1)e²/v) with the velocity v of the proton and the charge Z of the nucleus, where Coulomb hindrance prevails up to the Coulomb energy (Z−1)²e²/R with the nuclear radius R. The exponential rise of the starting (γ,xn) reaction cross sections is due to the increase in compound nucleus resonance level density.

If one looked into the photonuclear cross sections with higher resolution, one would observe individual resonances characterized by a width Γ. The cross section for a compound nucleus resonance of the (γ,x) reaction at the resonance energy Eᵣ is given by the Breit-Wigner formula

$$σ ( {E}_{γ} ) = {λ}_{γ}^{2} / 4 π \cdot g \cdot \frac{{Γ}_{γ} {Γ}_{d}}{{( {E}_{γ} - {E}_{r} )}^{2} + {Γ}^{2} / 4} \qquad ( 5 )$$

Herein, g is a spin factor close to unity. λ_{y}=/(E_{γ}·c) represents the wavelength of the γ rays with energy E_{γ}. Γ is the total width of the resonance with Γ=Γ_{γ}+Γ_{d}+Γ_{D} and the decay width Γₐ to the desired product and Γ_{D} to all other exit channels.

The width Γ_{y} has been studied systematically as a function of A at the neutron separation energy and we obtain an average <Γ_{γ}>≈100 meV for nuclei with A=160.

The energy spacing of the compound nuclear resonances for a given spin and parity at the neutron binding energy for A=160 is about D≈10 eV. Thus with a probability of <Γ>/D≈1% a resonance is hit.

For a given γ beam energy of 7 MeV, a bandwidth ΔE≈7 keV will cover about 700 resonances. The width γ_{γ}, has a Porter-Thomas distribution.

So most of the resonances have a very small γ width and very few levels show a much larger width. Thus from energy bin to energy bin we expect larger fluctuations of the average value within the bin and we can select an energy bin with a large cross section. The smaller the bandwidth of the γ-beam, the larger these fluctuations become and one may select e.g. bins with 10 times larger average cross section. Since the level spacings D grow exponentially when reducing the mass number A at the same excitation energy, these fluctuations become more pronounced for lighter nuclei.

The Doppler broadening of a γ transition at room temperature kT=1/40 eV for a nucleus with mass number A=160 and a γ energy E_{γ}=7 MeV is about 4 eV.

Thus the line is broadened with respect to the natural line width by a factor of z 40.

### Comparison of the Energy Loss in the Target Between Photonuclear and Ion-Induced Reactions

Gamma rays deposit their energy in quantized interactions with matter, such as Compton scattering, pair creation, photo effect or photonuclear reactions. For photon energies between 10 and 30 MeV the total cross-section is dominated by Compton scattering and pair production in the nuclear field. For 10 MeV γ quanta the angle of the Compton scattered γ-quanta is confined to about 10° and the cross section is strongly peaked in forward direction with an energy loss of less than 300 keV. If we assume a typical total cross section of 10 b/atom and a target thickness of 10⁶ atomic layers, about 5% of the γ quanta will suffer an energy loss by Compton scattering of 100 keV and about 5% will undergo pair creation at 10 MeV. However, in thin targets of less than 0.1 g/cm² less than 10⁻² of the electrons are stopped and less than 5*10⁻⁵ of the energy is deposited. Electrons are scattered very fast out of the target.

In contrast to gamma rays, charged particles deposit their energy continuously while being slowed down in matter. 10 MeV protons are stopped in 0.26 mm of iron. Thus we deposit per produced new radioactive nucleus about 400 MeV. The energy deposition is about a factor of 10⁵ larger for protons compared to γ's for the same number of produced nuclei.

The typical intensity of proton beams used for isotope production is of the order of 100 μA/cm², corresponding to 6×10¹²/(mm²s). On the other hand the target should withstand a γ flux density of 10¹⁵/[(0.1 mm)² s]. For Bremsstrahlung beams one has a strong rise of the γ spectrum to low energies with increased energy deposition at lower energies, making it worse compared to proton activation.

### Irradiation Target Configuration

The usable target thickness ranges from 20 g/cm² for heavy elements to 40 g/cm² for light elements, e.g. only few mg target material are exposed to the small area of the γ beam. With non-resonant reactions, activities on the order of 0.1 TBq can be produced per day, corresponding to tens (for β⁻ therapy isotopes) up to thousands (for imaging isotopes and therapy with a emitters such as ²²⁵Ac) of patient doses. The target elements may be used in the form of metals, oxides, carbides or other compounds, e.g. with light elements. Light elements have a relatively low cross section for gamma rays, hence the specific activity achieved with compound targets is not much lower compared to elemental targets.

The exact target geometry does not affect our estimates. In particular, a single compact target or a stack of thin target foils may be used. This would provide similar production rates. In practice the latter solution can stand far higher beam intensities. The foils may be radiation-cooled in vacuum or helium-cooled since helium has a low Z and correspondingly low cross section for interaction with gamma rays. Due to the low divergence of the gamma beam, the individual target foils can be spaced wide apart, thus reducing the view factors between the foils to minimize mutual heating by radiation absorption. For sufficiently thin foils most of the forward-directed Compton and pair electrons and positrons can leave the foil. Spacing the foils further apart reduces the energy deposition from electrons of the previous foil which deposit their energy laterally (e.g. in a water-cooled target chamber) spread over a wide area. The trajectories of the electrons and positrons may further be forced outward by applying a transversal magnetic field. Also a stack of target foils with thin water-cooling channels in between can be considered since hydrogen and oxygen have much lower interaction cross sections with gamma rays.

Alternatively or additionally to thin foils, also a thin wire or several consecutive wires may be placed along the γ beam direction. The wires may have a diameter on the order of e.g. 0.1 mm. Here, most electrons and positrons that are emitted under angles different from 0° will rapidly leave the target and will not contribute much to its heating. Even those that are initially emitted in a forward direction will rapidly change direction by scattering and then leave the wire. In particular, for less intense γ beams such a solution may be realized more simply than a multi-foil stack.

The target material may also be present in liquid form, e.g. in form of an aqueous solution, if the flux density of the γ beam is not too high. Even for a γ beam facility that provides a γ beam with high initial flux density and with several targets placed in a row, the flux density will be decreased. In order to make use of the γ beam with decreased intensity, the material of the downstream targets may be provided in aqueous form.

All these heat dissipation techniques rely on the small area, small divergence and small bandwidth of a gamma beam. They could not be applied for Bremsstrahlung spectra. Thus, the extremely high flux densities of gamma beams can really be utilized without being seriously limited by the required heat dissipation from the targets as is frequently the case for charged-particle induced reactions or intense Bremsstrahlung spectra. Instead of producing a single product isotope at a time, the target stack may also consist of different targets for simultaneous production of different isotopes. This is possible when the different reactions require similar γ energies. It may be particularly efficient when at least one of the reactions is characterized by prominent resonances reducing the interaction length for resonant γ rays. The “unused” γ rays within the bandwidth of the gamma beam may then be used downstream for other reactions that are not resonant or have resonances at different energies.

### Isomers of Stable Isotopes Via (γ,γ′)

Longer-lived nuclear isomers that decay by emission of gamma rays and/or conversion electrons to the respective ground state are of interest for various applications in nuclear medicine if they can be produced with high specific activity. Most usual production methods (e.g. via (n,γ) reactions) result in relatively low specific activity since the dominant part of the production proceeds directly to the nuclear ground state. We propose using γ beams with small band widths directed onto target nuclei. Selective excitation of regions of levels in (γ,γ′) reactions that decay preferentially to the nuclear isomer can enhance the specific activity of the isomer. Here, high resolution measurements from excitation energies of about 1 MeV up to close to the particle separation energy have to be performed with the new γ beams for each of the isotope for several thousand energy windows, to determine the best excitation de-excitation path to the isomer. Even multiple excitations of the path to the isomer are possible. Due to the missing energy match no significant back-pumping from the isomer to the ground state will occur.

Until now, very little is known about the population of high-spin isomers following the population of higher lying, low-spin compound nucleus resonances. In the past, the population of high-spin isomers relative to the ground state was studied for resonances in (n, γ) reactions. An energy dependence of the isomeric ratio was observed. One may expect that this energy dependence would become even more pronounced if the reactions were excited induced with a primary beam of smaller bandwidth. Note that in some cases the measured yields for the high-spin isomers are underestimated by theory by more than one order of magnitude, showing that the models, which e.g. do not take the spin and parity dependence of the level densities into account, have to be improved significantly. Two examples of long-lived isomers with important medical applications are discussed in the following:

^{195m}Pt: Platinum compounds such as cisplatin or carboplatin are known to be cytotoxic and are frequently used for chemotherapy. Labelling these compounds with platinum radiotracers allows for in-vivo pharmacokinetic studies and tumor imaging, e.g. to monitor the patient-specific uptake and optimize the dosing individually. Failure to demonstrate the tumour uptake of the chemotherapy agent by nuclear imaging helps to exclude those “non-responding” patients from unnecessary chemotherapy treatment.

^{195m}Pt has 4 days half-life and emits a 99˜keV gamma ray that can be used for imaging by SPECT or gamma cameras. ^{195m}Pt emits also low-energy conversion and Auger electrons. Hence, when used in higher activities it could be suitable for a combined chemo- and radionuclide therapy.

Unfortunately ^{195m}Pt is destroyed by (n, γ) reactions with a very high cross section of 13000 barn. Therefore the specific activity achievable by neutron capture on ¹⁹⁴Pt is seriously limited. Even at the HFIR reactor in Oak Ridge only 0.04 GBq/mg are obtained and too little activity is presently available for clinical trials.

By (γ,γ′) reactions we expect to obtain much higher specific activities, namely about 70 GBq/mg! About 20 GBq/mg could be produced per day, sufficient for several hundred patient-specific uptake measurements or to launch first clinical trials for radionuclide therapy with ^{195m}Pt. With specific gateway states the specific activity could be further improved. Moreover, even if natural platinum or platinum compounds are irradiated the radionuclidic purity of the product will be excellent since no other long-lived radioisotopes can be produced by activation with few MeV gamma rays.

^{117m}Sn: Also ^{117m}Sn emits low energy conversion and Auger electrons, making it promising for radionuclide therapy. In addition it emits a 159 keV gamma ray for imaging.

It has been shown that ^{117m}Sn can be used for pain palliation in bone metastases of various cancers. Due to its soft electron energy spectrum it has less side effects on the bone marrow than other radioisotopes with more penetrating radiation. Unfortunately the high-spin isomer ^{117m}Sn is poorly produced in thermal neutron capture on zero-spin ¹¹⁶Sn.

With inelastic neutron scattering ¹¹⁷Sn(n_{fast},n′γ)^{117m}Sn specific activities of 0.2 to 0.4 GBq/mg are obtained at high flux reactors, but too little activity is presently available. Production via (γ, γ′) reactions with 6 MeV γ beams allows boosting the specific activity at least to 7 GBq/mg, probably even higher with better gateway states.

The two isomers appear at present most interesting for nuclear medicine applications. The specific activity and total production per day could be significantly improved with b gateway states. Detailed search for suitable gateway states at an upcoming γ beam facility with small bandwidth is urgently needed.

Other long lived isomers that can be efficiently populated by (γ,γ′) reaction and that have applications in nuclear medicine or other fields, such as Mössbauer sources, are: ^{87m}Sr, ^{115m}In, ^{119m}Sn, ^{123m}Te, ^{125m}Te, ^{129m}Xe, ^{131m}Xe, ^{135m}Ba, ^{176m}Lu, ^{180m}Hf and ^{193m}Ir.

### Radioisotopes Via the (γ,n) Reaction

When being excited beyond the neutron binding energy a nucleus looses readily a neutron. Competing reactions such as de-excitation by gamma ray emission are far less probable.

1. ⁹⁹Mo/□^{99m}Tc: The presently most important radioisotope for nuclear medicine studies is ^{99m}Tc.

A facility providing 10¹⁵ gammas per s could produce via ¹⁰⁰Mo(γ,n) reactions several TBq per week. Thus, many such facilities would be required to assure the ⁹⁹Mo supply.

This first example demonstrates that the new production method by γ beams is not intended to compete with large-scale production of established isotopes. The advantage of γ beams for radioisotope production lies clearly in the very high specific activity that can be achieved for radioisotopes or isomers that are very promising for nuclear medicine but that are presently not available in the required quality. Examples of such isotopes will be discussed in the following.

2. ²²⁶Ra(γ,n)²²⁵Ra→²²⁵Ac: Alpha emitters are very promising for therapeutic applications, since the emitted alphas deposit their energy very locally (typical range of one to few cancer cell diameters) with high linear energy transfer (LET) and, hence, high probability for irreparable double strand breaks. An alpha emitter coupled to a cancer cell specific bioconjugate can be used for targeted alpha therapy to treat disseminated cancer types (leukaemia), micrometastases of various cancers or to destroy chemo- and radiation-resistant cancer cells (e.g. glioblastoma). One promising alpha emitter is ²²⁵Ac (T_{1/2}=10 days). It can either be used directly for targeted alpha therapy, or as generator for ²¹³Bi that is used for targeted alpha therapy. ²²⁵AC is produced in small quantities by decay of ²²⁹Th→²²⁵Ra→²²⁵Ac and chemical separation. Unfortunately too little separated ²²⁹Th is available to supply enough ²²⁵Ac. Today, only about 1 Ci is produced per year. Alternatively, ²²⁶Ra can be converted by (γ,n) reactions to ²²⁵Ra that decays to ²²⁵AC and is subsequently chemically separated from the ²²⁶Ra target. The radioactive ²²⁶Ra targets are difficult to handle when the activity of the target gets important. Therefore a narrowly focused gamma beam is particularly important to minimize the target size and target activity while maximizing the product activity.

3. ¹⁶⁹Er decays with 9.4 days half-life by low-energy beta emission (100 keV average beta energy). These betas have a range of 100 to 200 μm in biological tissue, corresponding to few cell diameters. The electron emitter can be used for targeted radiotherapy. Due to the low ¹⁶⁸Er(nₜₕ,γ) cross-section it cannot be produced with high specific activity by neutron capture. Using intense monochromatic γ beams one can reach higher specific activities via ¹⁷⁰Er(γ,n) reactions.

4. ¹⁶⁵Er: ¹⁶⁵Er is one example for an isotope that decays mainly by low-energy Auger electrons. Their range is shorter than one cell diameter. Hence, these Auger emitters have to enter the cell and approach the cell's nucleus to damage the DNA and destroy a cell. Coupled to a bioconjugate that is selectively internalized into cancer cells it can significantly enhance the ratio for absorbed in the tumor cell with respect to normal cells. This should result in an improved tumor treatment with less side effects. Research to identify suitable bioconjugates is currently under way.

5. ⁴⁷SC is a promising low-energy beta emitter for targeted radiotherapy. Most established labelling procedures for valence 3 metals (Y, Lu, . . . ) can be applied directly for Sc. With intense gamma beams the production via ⁴⁸Ca(γ,n)⁴⁷Ca→⁴⁷Sc becomes competitive.

6. ⁶⁴Cu is a relatively long-lived β⁺ emitter (T_{1/2}=12.7 h) with various applications in nuclear medicine. ⁶⁴Cu-ATSM is a way to measure hypoxia of tumors. Hypoxia is an important effect influencing the resistance of tumor cells against chemo- or radiation therapy.

⁶⁴Cu can also act itself as therapeutic isotope due to its emission of β⁻ (191 keV mean energy) and low energy Auger electrons. Today ⁶⁴Cu is mainly produced with small cyclotrons by the ⁶⁴Ni(p,n) reactions. Alternative production by ⁶⁵Cu(γ,n) does not require the rare and expensive ⁶⁴Ni targets and saves the chemical separation step.

7. ¹⁸⁶Re is a radioisotope suitable for bone pain palliation, radiosynovectomy and targeted radionuclide therapy. Rhenium is chemically very similar to its homologue technetium, thus known compounds that have been developed for imaging with ^{99m}Tc can also be labelled with ¹⁸⁶Re and used for therapy. ¹⁸⁶Re is currently either produced by neutron capture on ¹⁸⁵Re, resulting in limited specific activity, or by ¹⁸⁶W(p,n) reactions followed by chemical Re/W separation. The latter guarantees excellent specific activity at the expense of much reduced production rates and a required chemical separation. Production by ¹⁸⁷Re(γ,n) would allow producing larger amounts (2 TBq per week) of ¹⁸⁶Re with high specific activity.

Enriched ¹⁸⁷Re targets may be used to minimize contamination of the product with long-lived ^{184,184m}Re by ¹⁸⁵Re(γ,n) reactions.

### “Slightly Neutron-Deficient” Radioisotopes

Slightly neutron-deficient isotopes are decaying by electron capture with emission of X-rays and low-energy Auger electrons, partially also gamma rays and conversion electrons. The absence of beta emission and the presence of low-energy X-rays or electrons is of advantage for a variety of applications such as calibration sources, radionuclide therapy applications after internalization into cells, etc. All these isotopes can be produced by neutron capture on the stable (A−1) neighboring isotope. However, the latter is usually very rare in nature (since only produced by unusual astrophysical processes like the p-process) and correspondingly costly when produced as isotopically enriched target material. Using instead (γ,n) reactions to populate the same isotopes allows using the much more abundant, and hence cheaper, (A+1) neighboring isotope as target. An example is ¹⁰³Pd, a low-energy electron emitter. It can be used for targeted radiotherapy (coupled to a suitable bioconjugate) or for brachytherapy applications where sources (“seeds”) are inserted into a cancer (e.g. breast cancer) for localized irradiation. However, the target ¹⁰²Pd for production by neutron capture is rare and expensive. Production via ¹⁰⁴Pd(γ,n) is more economic, if sufficiently intense gamma beams are available. Similar arguments apply for other isotopes produced in (γ,n) reactions, which are not necessarily neutron deficient: ⁴⁷Ca, ⁵¹Cr, ⁵⁵Fe, ⁷⁵Se, ⁸⁵Sr, ¹⁰⁷Cd, ¹⁰⁹Cd, ¹²¹Cd, ¹²¹Te, ^{121m}Te, ¹²⁷Xe, ^{133m}Ba, ¹³³Ba, ¹³⁹Ce, ¹⁵³Gd, ¹⁵⁹Dy, ¹⁶⁵Er, ¹⁶⁹Yb, ¹⁷⁵Hf, ¹⁸¹W, ¹⁹¹Pt, ^{193m}Pt.

Even if the natural abundance of the target isotope is low, the production by gamma beam induced (γ,n) reactions can be favourable over conventional production schemes since a high specific and/or a high total activity may be achieved or since a high activity can be achieved more economically. Moreover, production via (γ,n) reactions with a gamma beam may have other advantages such as an improved radioisotopic purity, easier chemical processing, etc. Therefore, also the production of ⁶⁴CU, ⁷¹Ge, ⁹⁷Ru, ¹¹³Sn and ¹⁸⁶Re is possible by (γ,n) reactions.

### (γ,p) Reactions

Neutron emission competes with proton emission and the cross-sections for (γ,p) reactions may be one order of magnitude lower than the competing channels (compare FIG. 6. Thus, the achievable specific activity (specific activity with respect to the target mass) is limited for (γ,p) reactions. However, the product isotope differs chemically from the target since it has one proton less (Z_{product}=Z_{target}−1). After irradiation a chemical separation of the product isotope from the target can be performed, ultimately resulting in a high specific activity that is only compromised by competing reactions leading to other isotopes of the product element (such as (γ,np), (γ,2n)EC/β⁺, etc.) or product burnup by (γ,n).

1. ⁴⁷Sc can also be produced via the ⁴⁸Ti(γ,p)⁴⁷Sc reaction. Compared to the ⁴⁷Ti(n,p) way here the production of disturbing long-lived ⁴⁶Sc (via ⁴⁶Ti(n,p) or ⁴⁷Ti(γ,p) respectively) can be reduced more easily, since ⁴⁸Ti is the most abundant titanium isotope and can be enriched more easily to high abundance. The established Sc/Ti separation schemes can be employed for the chemical processing.

2. ⁶⁷Cu is also a promising beta-emitter for targeted radiotherapy. Together with the PET imaging isotopes ⁶¹Cu and ⁶⁴Cu it provides a matched pair. Production via ⁶⁸Zn(γ,p) reactions with intense gamma beams provides higher yields than current production schemes and uses more abundant, and, hence cheaper ⁶⁸Zn targets. The established Cu/Zn separation schemes can be employed for the chemical processing.

3. In principle also heavier beta-emitters used for radionuclide therapy such as ¹³¹I, ¹⁶¹Tb or ¹⁷⁷Lu could be produced by (γ,p) reactions. However, for higher Z the increasing Coulomb barrier leads to small production cross sections that are not competitive to production in high flux reactors.

### Radioisotopes Via the (γ,2n) Reaction

1. ⁴⁴Sc is a promising metallic PET emitter. It represents a matched pair with ⁴⁷Sc, a therapy isotope. Activation of natural Ti or enriched ⁴⁶Ti (natural abundance 8%) allows producing ⁴⁴Ti, a long-lived (T_{1/2}=60 years) generator isotope for ⁴⁴Sc.

2. ²²⁶Ra(γ,2n)²²⁴Ra from the thorium chain can be obtained, where the noble gas ²²⁰Rn isotope can be extracted easily. The α emitter ²¹²Bi in this decay chain or its mother isotope ²¹²Pb are also considered for cancer therapy.

3. Also the PET isotope generator isotopes ⁶⁸Ge and ⁸²Sr and the in-vivo PET isotope generator ¹⁴⁰Nd may be produced by (γ,2n) reactions on ⁷⁰Ge, ⁸⁴Sr and ¹⁴²Nd targets, respectively.

### Other Reaction Channels

In (γ,2p) reactions even two protons must overcome the Coulomb barrier, making this reaction channel even less likely than the (γ,p) reaction. Also for (γ,α) reactions the higher Coulomb barrier leads to small cross-sections in the μbarn range. Usually other production reactions provide better yields, making these types of photonuclear reaction less competitive.

Photo-fission of uranium or thorium targets allows production of ⁹⁹Mo and other isotopes with highest specific activity. However, the here proposed γ-beams with high flux density are not suitable since they lead to an excessive target heating.

### Photonuclear Activation for Brachytherapy Applications

Certain nuclear medicine applications use the radioisotopes “directly”, i.e. not necessarily coupled to a bio-molecule.

There are various applications for micro- or nanoparticles that are doped with radioisotopes.

They can be used for intratumoral injection, e.g. to treat liver metastases. When injected locally, macrophages will detect these particles and absorb them. These macrophages have then a high probability to “get stuck” in parts of the liver that are obstructed by tumor metastases. The radioisotopes contained in the micro- or nanoparticles can then irradiate these metastases with their medium-range radiation (beta particles or low-energy X-rays or gamma rays). The radioisotopes can be introduced into the micro- or nanoparticles in various ways:

1. The radioisotopes can be added to the raw materials used in the chemical synthesis of the micro- or nanoparticles. However, this makes the processing much more involved since radioactive material has to be handled and the respective radiological and contamination issues have to be addressed in the production facility.

2. The radioisotopes can be implanted in form of a radioactive ion beam into the ready-made micro- or nanoparticles. This method is quite universal, allowing to dope even with radioisotopes of elements that are usually not soluble in or chemically compatible with the matrix. However, the radioactive isotopes first need to be brought into a radioactive ion beam which may be more involved depending on the chemical element.

3. A stable precursor of the radioisotope can be introduced prior to the chemical synthesis of the micro- or nanoparticles or ion-implanted after synthesis. Then the precursor is transmuted in a nuclear reaction into the desired radioisotope. However, the micro- or nanoparticles may be sensitive to radiation damage. Hence activation e.g. in a nuclear reactor could damage them such that they are no longer usable in in-vivo applications. For neutron activation it has been shown that resonance capture of epithermal neutrons (“adiabatic resonance crossing” method) can be of advantage to overcome this problem. Here, we propose a complementary method of activation by photonuclear reactions. For the isotopes listed in Table 2 the general advantages discussed above apply. In addition the high cross-section ratio of “useful” photonuclear reactions versus “disturbing” reactions causing radiation damage allows obtaining much higher activities.

Radioisotopes can also be bound in larger solid matrices that are then mechanically (surgically) introduced into the body or brought close to it to irradiate tumors or benign diseases. Such a so-called brachytherapy is today routinely used to treat prostate cancer by permanently introduced seeds containing radioactive ¹²⁵I. It is also useful to prevent in-stent restenosis by intravascular brachytherapy using radioactive stents, to prevent closure of the pressure relief channel in glaucoma filtering surgery by radioactive implants or to perform other anti-inflammatory or anti-proliferative treatments. Photonuclear reactions could simplify the production of the respective stents or seeds. Instead of introducing the radioactive isotopes in the production process or ion-implanting it afterwards it will be possible to produce the stents or seeds in their final form and then activate a previously included stable precursor isotope by photonuclear reactions. Selective photonuclear reactions assure to keep the radiation damage of the matrix negligible and avoid an unwanted production of disturbing radioisotopes by activation of the matrix.

### Advantages of the Proposed Photonuclear Reaction Over Existing Technologies

The intense brilliant gamma beam will allow to produce radioisotopes with rather high specific activity very economically. Advantages of gamma beams with small opening angle are as follows:

The produced radioisotopes are concentrated in a small target volume, hence resulting in much higher specific activity than usual. Moreover, much less of the (often costly) target material is required. Small targets make subsequent radiochemical processing easier and more efficient.

In addition, radioactive targets are more efficiently converted into the required product isotopes, hence more compact and less active targets can be employed, resulting in less activity to be handled and less dose rate.

A further advantage of using the low bandwidth gamma beams is that the higher cross-section for monochromatic beams leads to a short interaction length (cm or less). This leads to an additional reduction of the required target mass. This reduces further the target costs and increases correspondingly the specific activity.

Compared to Bremsstrahlung beams a much reduced γ ray heating per useful reaction rate occurs since the γ rays in the useful energy range are not accompanied by an intense low-energy tail. Moreover the usual equilibrium between γ-rays and electrons (which are responsible for the actual heating) will build up only for very thick targets.

Much reduced radiation damage due to quasi-monochromatic beams will make it possible to first dope and then activate materials (e.g. organic, nanoscale, . . . ) that would not withstand irradiation in a nuclear reactor or a Bremsstrahlung γ ray spectrum.

Isotopic enrichment may not necessarily be needed, when for a given gamma energy the wanted cross section is much higher than for other isotopes. In particular the fine structure of the Pygmy dipole resonance (PDR), probably similar to the giant dipole resonance (GDR), could be exploited.

Also less stringent requirements exist concerning isotopic enrichment or chemical impurities of the target materials if the γ ray energy is chosen such that the maximum cross sections of the wanted production channels correspond to minima in the cross section of activation of impurities. Moreover, selective production reduces the overall activity level of the irradiated target and reduces the challenge to the chemical post-processing.

Moreover there are practical advantages of photonuclear reactions compared to charged-particle induced reactions:

Radioactive targets like ²²⁶Ra or targets that risk to react heavily in contact with cooling water (e.g. alkali metals) can be safely encapsulated into relatively thick metal walls since gamma rays penetrate easily and cause little heating of the walls.

A further optional increase of the specific activity is possible by one or more of the following:
1. Using enriched target isotopes.
2. A thin target or a stack of thin target foils interleaved with a different solid, liquid or gas may act as a catcher of recoil ions. Extraction and separation of the recoiled isotopes can be performed with the usual radiochemical methods.
3. Moreover, if the produced radioisotope belongs to a different chemical element than the target (e.g. for (γ,p) reactions), a usual radiochemical post-processing (e.g. ion exchange chromatography, liquid-liquid extraction, etc.) can be employed to separate the product element from remainders of the target element and thus increase the specific activity of the product.
4. In addition, a product isotope that decays to a radioactive daughter isotope with medical applications allows producing a generator.

Using the new gamma beam facilities one can use compact targets, which are exposed to the gamma radiation and undergo photonuclear reactions such as (γ,γ′), (γ,n), (γ,p), (γ,2n) to form radioisotopes. After a suitable irradiation time, a radioisotope with high specific activity is produced. After the usual radiochemical and radiopharmaceutical steps (such as optionally dissolving of the target, optionally chemical purification, optionally labelling, quality control, . . . ) a radiopharmaceutical product is created for use in diagnostic or therapeutic nuclear medicine procedures. The produced radioisotope may be used directly for nuclear medicine applications.

The investment and running costs of the proposed γ-beam facility are on the order of 40 MEUR and few MEUR/year. This is cheaper than a high flux reactor, but more expensive than compact cyclotrons that provide charged particles with 10 to 20 MeV suitable for production of PET tracers. World-wide more than 600 such cyclotrons exist, often based at hospitals or close-by. They provide regularly the short-lived PET isotopes ¹⁸F, ¹¹C, ¹³N and ¹⁵O for molecular imaging applications. Although it would be possible to produce also such isotopes by photonuclear reactions (e.g. ²⁰Ne(γ,np)¹⁸F), a more complex Compton back-scattering facility would be an overkill for such applications.

The main advantage of the gamma beam facility is the new and rather unique access to radioisotopes or isomers with high specific activity that can complement and extend the choice of radioisotopes for nuclear medicine applications.

### REFERENCE SIGNS

1 electron beam
2′, 2 laser pulse
3, 4 mirror
5, 7 gamma beam
6, 8, 10 target
9 envelope
10 electron source
11 energy recovery linac (ERL)
12 beam dump
20, 20′, 40, 40′ auxiliary mirrors
22, 22′ laser pulse
23, 24 mirror
25 gamma beam
26 second target
27 neutron
28 converter target
29 detector
30 feedback signal lead
50, 51 crystal
52 gamma (γ) beam
53 position sensitive detector
54 collimator
80 single refractive γ-lens
81 parabolic surface of single refractive γ-lens 80
82 gamma (γ) ray

1. A method for producing a radionuclide product B comprising:
providing a target having an amount of a nuclide A,
providing a gamma beam by Compton back-scattering of laser light from an electron beam,
irradiating the target by the gamma beam, thereby transmuting at least a portion of the amount of the nuclide A into the product B,
wherein providing the target comprises selecting a nuclide A, such that A is transmutable into product B by one of a (γ, γ′) reaction or a (γ, n) reaction, and
wherein providing said gamma beam comprises providing a gamma beam with a photon energy between 0.5 and 10 MeV in case of a (γ, γ′) reaction and between 5 and 20 MeV in case of a (γ, n) reaction.

2. The method according to claim 1, wherein providing the gamma beam comprises providing the gamma beam with an adjustable photon energy and adjusting the photon energy in accordance with the product B and the selected nuclide A.

3. The method according to claim 1, wherein providing the gamma beam comprises providing the electron beam by a LINAC.

4. The method according to claim 3, wherein said LINAC is one of an energy recovery linac (ERL) or a warm linac, or a laser-driven electron beam.

5. The method according to claim 1, wherein the target comprises the nuclide A in enriched form or in natural abundance.

6. The method according to claim 1, wherein providing the gamma beam comprises providing the gamma beam with a flux density at the target between 10¹¹ and 10²⁰ γ/(s cm²).

7. The method according to claim 1, wherein providing the gamma beam comprises providing the gamma beam with an opening angle of less than 10 mrad.

8. The method according to claim 1, wherein providing the gamma beam comprises providing the gamma beam with an intensity of between 10¹¹ and 10¹⁷ photons per second.

9. The method according to claim 1, wherein providing the gamma beam comprises providing the gamma beam with an energy bandwidth FWHM between 10⁻² and 10⁻¹⁰.

10. The method according to claim 1, wherein providing the gamma beam comprises providing the gamma beam with a cross section between 1 μm² and 10 mm² at the target.

11. The method according to claim 1, comprising selecting the nuclide A depending on the desired radionuclide product B from the following list of combinations of nuclide A, nuclear reaction, and radionuclide B:
¹⁹⁵Pt(γ,γ′)^{195m}Pt, ²²⁶Ra(γ,n)²²⁵Ra, ⁴⁸Ca(γ, n)⁴⁷Ca, ¹⁰⁴Pd(γ,n)¹⁰³Pd, ⁶⁵Cu(γ,n)⁶⁴Cu, ¹⁶⁶Er(γ,n)¹⁶⁵Er, ¹⁷⁰Er(γ,n)¹⁶⁹Er, ¹⁸⁷Re(γ,n)¹⁸⁶Re, ¹¹⁷Sn(γ,γ′)^{117m}Sn, ⁸⁷Sr(γ,γ′)^{87m}Sr, ¹¹⁵In(γ,γ′)^{115m}In, ¹¹⁹Sn(γ,γ′)^{119m}Sn, ¹²³Te(γ,γ′)^{123m}Te, ¹²⁵Te(γ,γ′)^{125m}Te, ¹²⁹Xe(γ,γ′)^{129m}Xe, ¹³¹Xe(γ,γ′)^{131m}Xe, ¹³⁵Ba(γ,γ′)^{135m}Ba, ¹⁷⁶Lu(γ,γ′)^{176m}Lu, ¹⁸⁰Hf(γ,γ′)^{180m}Hf, ¹⁹³Ir(γ,γ′)^{193m}Ir, ⁵²Cr(γ,n)⁵¹Cr, ⁵⁶Fe(γ,n)⁵⁵Fe, ⁷²Ge(γ,n)⁷¹Ge, ⁷⁶Se(γ,n)⁷⁵Se, ⁸⁶Sr(γ,n)⁸⁵Sr, ⁹⁸Ru(γ,n)⁹⁷Ru, ¹⁰⁸Cd(γ,n)¹⁰⁷Cd, ¹¹⁰Cd(γ,n)¹⁰⁹Cd, ¹¹⁴Sn(γ,n)¹¹³Sn, ¹²²Te(γ,n)¹²¹Te, ¹²²Te(γ,n)^{121m}Te, ¹²⁸Xe(γ,n)¹²⁷Xe, ¹³⁴Ba(γ,n)¹³³Ba, ¹³⁴Ba(γ,n)^{133m}Ba, ¹⁴⁰Ce(γ,n)¹³⁹Ce, ¹⁵⁴Gd(γ,n)¹⁵³Gd, ¹⁶⁰Dy(γ,n)¹⁵⁹Dy, ¹⁷⁰Yb(γ,n)¹⁶⁹Yb, ¹⁷⁶Hf(γ,n)¹⁷⁵Hf, ¹⁸²W(γ,n)¹⁸¹W, ¹⁹²Pt(γ,n)¹⁹¹Pt, ¹⁹⁴Pt(γ,n)^{193m}Pt.

12. The method according to claim 1, wherein the step of providing the γ beam further comprises stabilizing the γ beam by monitoring at least one of the γ beam energy and the γ beam energy bandwidth, and adjusting the electron beam in accordance with a result of the monitoring.

13. The method according to claim 12, wherein the step of monitoring comprises either
sending a second γ beam from a γ beam production station being at least partially arranged in the electron beam to a dedicated second target, thereby releasing neutrons from the dedicated second target, and measuring the released neutron energy, or
measuring a Bragg angle of a portion of the γ beam that is Bragg-diffracted by a crystal provided in the γ beam.

14. The method according to claim 1, wherein the method further comprises at least one step of coupling an amount of radionuclide B with a molecule such as to form a bioconjugate.

15. The method according to claim 1, wherein the method further comprises storing the irradiated target for a period of time allowing the radionuclide product B to decay into a radionuclide end-product C.

16. The method according to claim 15, wherein A, B, C are selected from a group comprising ²²⁶Ra, ²²⁵Ra, ²²⁵Ac and ⁴⁸Ca, ⁴⁷Ca, ⁴⁷Sc.

17. The method according to claim 15, wherein the period of time is between 0.1 and 3 times the half-life T_{1/2}.

18. The method according to claim 1, wherein the method further comprises:
providing n targets, each comprising an amount of a respective nuclide Aⁱ, wherein the nuclides Aⁱ may be identical or different,
positioning the n targets in a row one behind the other along the direction of the gamma beam,
irradiating the targets, thereby transmuting at least a portion of the amount of each nuclide Aⁱ into the respective radionuclide product Bⁱ, wherein
i is an integer between 1 and n, where n is between 2 and 1000.

19. The method according to claim 1, wherein the target comprises an implantable product.

20. The method according to claim 19, wherein the implantable product comprises one of a stent, a seed, a biodegradable implant, and micro- or nanoparticles.

21. An apparatus adapted for producing a radionuclide product B according to the method of claim 1 comprising:
an electron accelerator for providing the electron beam,
a laser light source for providing the laser light,
means for performing Compton back-scattering of the laser light from the electron beam for generating the gamma beam,
means for holding or receiving the target, such that when held or received the target is at least partially positioned within the gamma beam.

22. The apparatus of claim 21, wherein the electron accelerator is adapted to provide the electron beam with at least one adjustable parameter, wherein the at least one parameter comprises one of an electron beam energy and an electron beam energy bandwidth.

23. The apparatus according to claim 22, wherein the apparatus further comprises
a γ beam production station being at least partially arranged in the electron beam and further being adapted to generate a second γ beam,
a second target being adapted to release neutrons upon irradiation by the second γ beam, and
means for measuring the energy of neutrons released by the second target.

24. The apparatus according to claim 21, wherein the apparatus further comprises at least one additional laser light source for providing at least one additional laser light beam,
additional means for performing Compton back-scattering of the at least one additional laser light beam from the electron beam for generating at least one additional gamma beam, and
additional means for holding or receiving at least one additional target, such that when held or received each of the at least one additional targets is at least partially positioned within the at least one additional beam, respectively.

25. The apparatus of claim 21, further comprising an irradiation chamber, wherein the irradiation chamber has means for holding or receiving two or more targets aligned along a direction of the γ beam.

26. The apparatus according to claim 21, further comprising an irradiation chamber adapted to contain the one or more targets and to contain one of a vacuum, a gas or a liquid, and wherein the irradiation chamber comprises inlet and outlet means for a gas or a liquid.
